(19) United States
(12) Patent Application Publication
(10) Pub. No.: US 2009/0094635 A1
(43) Pub. Date: Apr. 9, 2009

(54) System and Method for Presenting Advertisement Content on a Mobile Platform During Travel

(76) Inventors: Matthew J. Aslin, Laguna Beach, CA (US); Andy Mitchell, Cobham (GB); Suzanne Luxem, Mission Viejo, CA (US); Cherie Song, Irvine, CA (US); Tim Strike, Toronto (CA); Ranjit K. Dhaman, Sunnyvale, CA (US); Ian Walberg, Ladera Ranch, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/245,521

(22) Filed: Oct. 3, 2008

Related U.S. Application Data
(60) Provisional application No. 60/977,760, filed on Oct. 5, 2007.

(51) Int. Cl. H04N 7/10; H04N 7/18

(52) U.S. Cl. 725/32; 725/76

(57) ABSTRACT

An advertisement system for passenger vehicles, such as automobiles and aircraft, and methods for manufacturing and using same. The advertisement system includes at least one advertisement content source that is configured to communicate with a vehicle information system installed aboard the passenger vehicle. When a system user selects viewing content available from the vehicle information system for presentation, the advertisement content source can combine advertising content with the selected viewing content to generate an aggregate play list. During presentation of the aggregate play list, the advertisement system can measure and/or analyze the user response to the presented advertisement content. The advertisement system advantageously can be provided as a part of an overall strategy for managing sales of advertising and providing advertisement-trafficking services via an interactive vehicle information system.

### CROSS-REFERENCE TO RELATED APPLICATIONS

This application claims priority to U.S. provisional patent application, Ser. No. 60/977,760, filed on Oct. 5, 2007. Priority to the provisional patent applications is expressly claimed, and the disclosure of the provisional application is hereby incorporated herein by reference in its entirety and for all purposes.

### FIELD

The present disclosure relates generally to information systems and more particularly, but not exclusively, to vehicle information systems suitable for presenting selected advertisement content during travel.

### BACKGROUND

Vehicles, such as automobiles and aircraft, often include vehicle information systems for satisfying passenger demand for access to viewing content, such as entertainment, information content, or other viewing content, while traveling.

Conventional passenger information (or entertainment) systems typically include overhead cabin video systems or seat-based video systems with individual controls such that viewing content is selectable by the passengers. The viewing content can include audio and video content that is derived from a variety of content sources. Prerecorded viewing content, such as motion pictures and music, can be provided by internal content sources, such as audio and video players, that are installed aboard the vehicle. The conventional passenger information systems likewise can include an antenna system for receiving viewing content, such as live television programming and/or Internet content, transmitted from one or more content providers (or sources) that are external to, and/or remote from, the vehicle.

Further, vehicle passengers have long been considered to be an attractive and valued audience by advertisers. During travel, the vehicle provides an environment wherein the passengers comprise an audience that is literally waiting to be engaged. Media planners (or buyers) and other advertisers are looking for exactly such an audience. Although interactive entertainment and other information availability at the passenger seats has become widespread over the past ten years, the presentation of advertisement content during travel remains a low priority for media planners. One roadblock to providing advertisement content during travel is a lack of a “single” travel media. Instead, dozens of different media forms and networks exist and are scattered throughout the world. Hundreds of individual value propositions are sold through many different channels; however, the individual value propositions are fragmented, difficult to understand, inefficient to purchase, and largely unaccountable with respect to campaign performance.

In view of the foregoing, a need exists for an improved passenger information system and method for presenting advertisement content during travel in an effort to overcome the aforementioned obstacles and deficiencies of conventional passenger information systems.

### BRIEF DESCRIPTION OF THE DRAWINGS

FIG. 1A is an exemplary top-level drawing illustrating an embodiment of an advertisement system, wherein the advertisement system includes an advertisement content system that is in communication with an information system.

FIG. 1B is an exemplary top-level drawing illustrating an alternative embodiment of the advertisement system of FIG. 1A, wherein the advertisement system is provided as an Internet-based advertisement server system.

FIG. 2A is an exemplary top-level drawing illustrating the information system of FIG. 1, wherein the information system comprises a vehicle information system installed aboard an automobile.

FIG. 2B is an exemplary top-level drawing illustrating the vehicle information system of FIG. 2A, wherein the vehicle information system is installed aboard an aircraft and is configured to communicate with the content system of FIG. 1.

FIG. 3 is an exemplary detail drawing illustrating one preferred embodiment of a distribution system for the vehicle information systems of FIGS. 2A-B.

FIG. 4A is an exemplary top-level drawing illustrating a passenger cabin of a vehicle, wherein the vehicle information system of FIGS. 2A-B has been installed.

FIG. 4B is an exemplary top-level drawing illustrating an embodiment of the vehicle information system of FIG. 4A, wherein the vehicle information system is in communication with the personal media device of FIG. 1.

FIG. 5A is an exemplary block diagram illustrating an embodiment of the advertisement system of FIGS. 1A-B, wherein the advertisement system is configured for use with the vehicle information system of FIG. 2B.

FIG. 5B is an exemplary block diagram illustrating an embodiment of a menu system for use with the advertisement system of FIG. 5A, wherein the menu system includes an advertisement impression for selecting targeted advertising content.

FIG. 6 is an exemplary block diagram illustrating an alternative embodiment of the advertisement system of FIGS. 1A-B, wherein the vehicle information system includes an advertisement content source.

FIGS. 7A-Z are exemplary block diagrams illustrating a selected operation of the advertisement system of FIG. 6, wherein advertisement content is included with viewing content selected for presentation at a passenger seat.

FIG. 8 is an exemplary detail drawing illustrating an embodiment of the advertisement system of FIG. 6.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

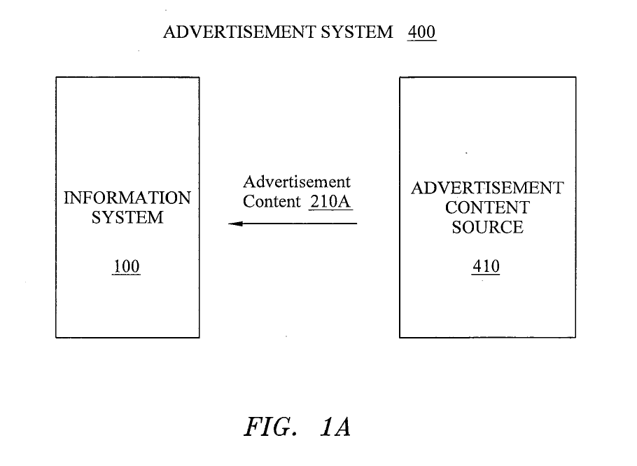

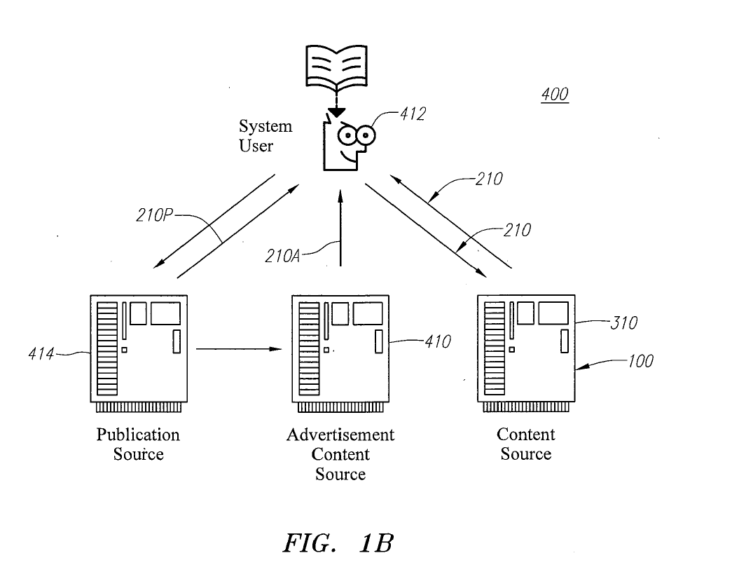

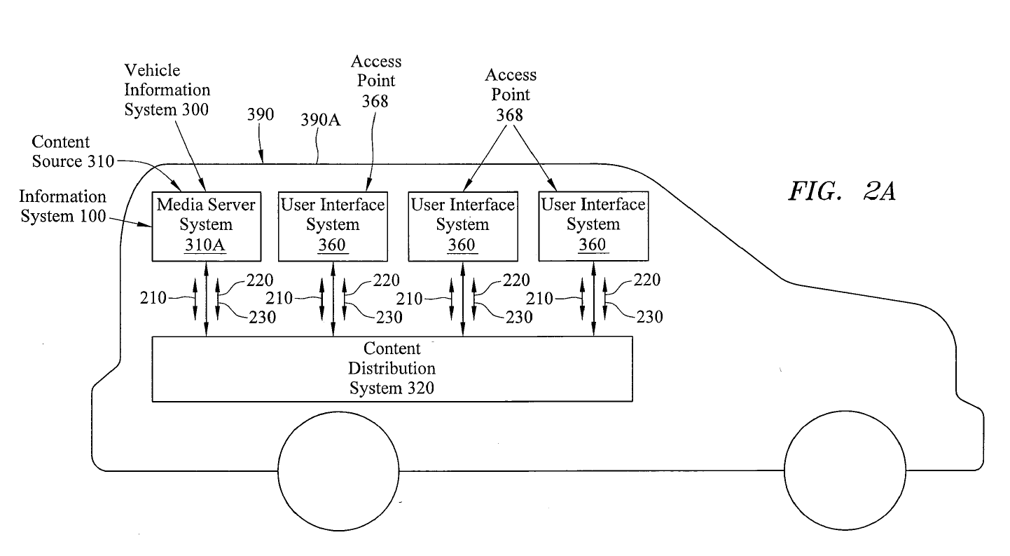

Since currently-available passenger information systems are not suitable for presenting advertisement content due to fragmentation, complexity, and a lack of standards, an information system that can present advertisement content can prove desirable and provide a basis for a wide range of system applications, such as vehicle information systems for use aboard automobiles, aircraft, and other types of vehicles during travel. This result can be achieved, according to one embodiment disclosed herein, by an advertisement system 400 as illustrated in FIG. 1A.

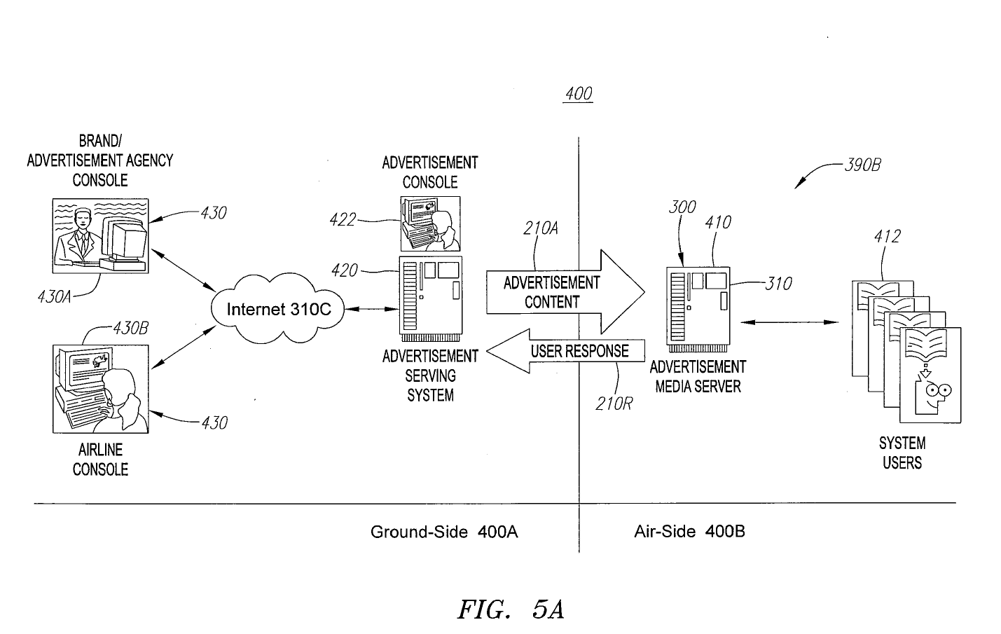

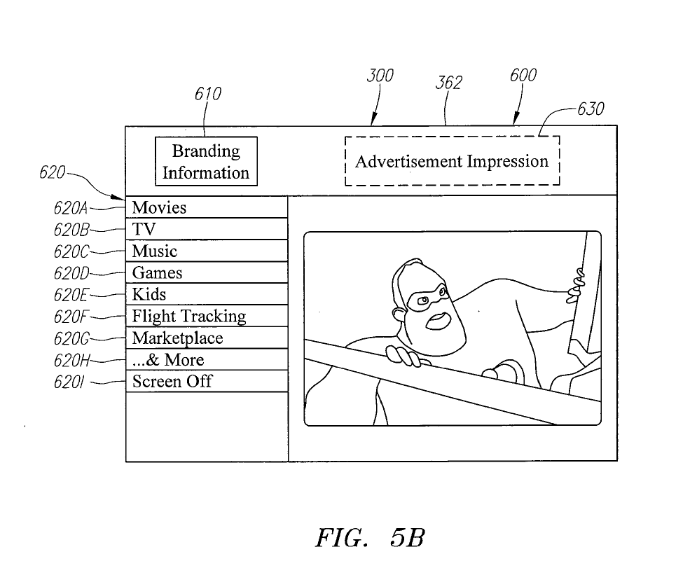

Turning to FIG. 1A, the advertisement system 400 can include at least one advertisement content source 410 that is configured to communicate with at least one information system 100. The advertisement system 400 advantageously can be provided as a part of an overall strategy for managing sales of advertising and providing advertisement-trafficking services via the interactive information system 100. For example, the advertisement system 400 can support sales of “new media” advertising in the form of banners, pop-ups, buttons, skyscrapers, and/or micro-sites in any conventional size, geometry, orientation, and/or media format, such as a static format and/or a rich-media format. The “new media” advertising can be provided in any conventional manner, such as via one or more impressions 630 (shown in FIG. 5B).

Exemplary advertisement-trafficking services for a selected advertising campaign can include programming advertisement content 210A for the advertising campaign into the advertisement content source 410, presenting the programmed advertisement content 210A via the information system 100, measuring a user response 210R (shown in FIG. 5A) to the presented advertisement content 210A, and/or analyzing the measured user response 210R. The advertisement system 400 thereby can enable advertisers (or advertising agencies) to reach a large, diverse group of system users (or passengers) 412 (shown in FIG. 1B) who use the information system 100. As such, use of the information system 100 can be commercialized, improving advertiser access to system users 412, while enhancing the user experience.

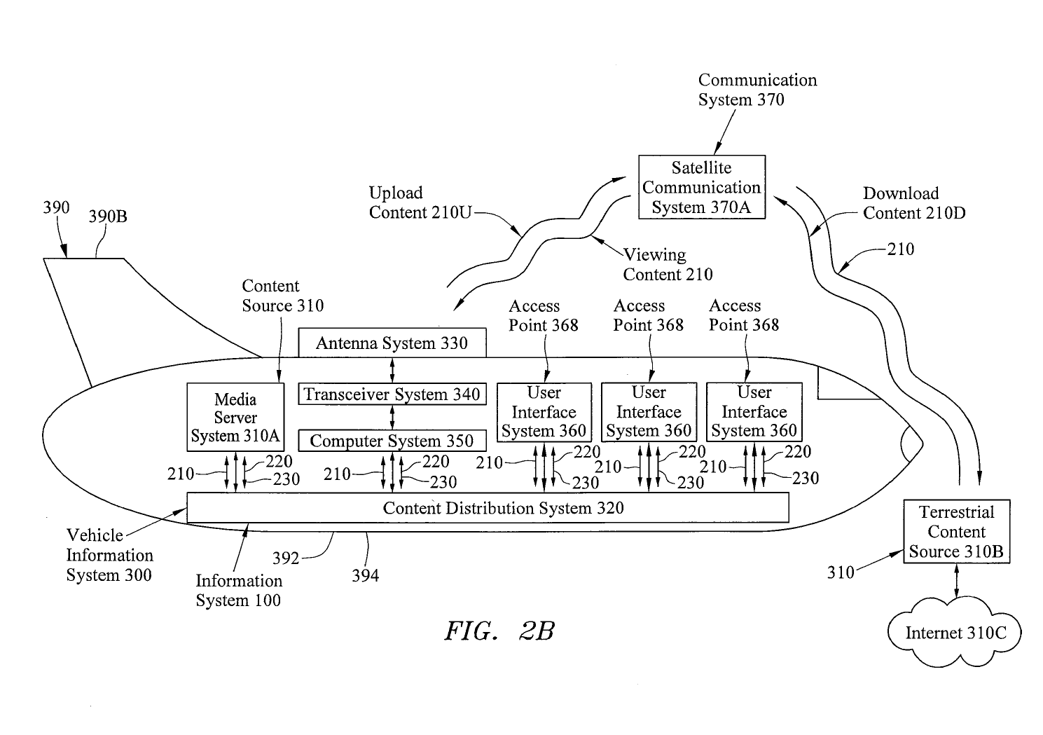

To implement this overall strategy, the advertisement system 400 can provide a service-delivery infrastructure for developing, deploying, and/or managing an advertisement-sales system, advertisement-trafficking system, and/or an advertisement-serving system 420 (shown in FIG. 5A). The advertisement system 400 thereby can be provided in the manner that systems and/or services are available on the Internet 310C (shown in FIG. 2B). For example, each advertisement content source 410 can be provided in the manner set forth in the co-pending U.S. patent applications, entitled “SYSTEM AND METHOD FOR DOWNLOADING FILES,” Ser. No. 10/772,565, filed on Feb. 4, 2004; entitled “SYSTEM AND METHOD FOR MANAGING CONTENT ON MOBILE PLATFORMS,” Ser. No. 11/123,327, filed on May 6, 2005; entitled “PORTABLE MEDIA DEVICE AND METHOD FOR PRESENTING VIEWING CONTENT DURING TRAVEL,” Ser. No. 11/154,749, filed on Jun. 15, 2005; and entitled “SYSTEM AND METHOD FOR RECEIVING BROADCAST CONTENT ON A MOBILE PLATFORM DURING INTERNATIONAL TRAVEL,” Ser. No. 11/269,378, filed on Nov. 7, 2005; entitled “SYSTEM AND METHOD FOR INTERFACING A PORTABLE MEDIA DEVICE WITH A VEHICLE INFORMATION SYSTEM,” Ser. No. 12/210,624, filed on Sep. 15, 2008; entitled “PORTABLE USER CONTROL DEVICE AND METHOD FOR VEHICLE INFORMATION SYSTEMS,” Ser. No. 12/210,689, filed on Sep. 15, 2008; and entitled “SYSTEM AND METHOD FOR RECEIVING BROADCAST CONTENT ON A MOBILE PLATFORM DURING TRAVEL,” application Ser. No. 12/237,253, filed on Sep. 24, 2008, which are assigned to the assignee of the present application and the respective disclosures of which are hereby incorporated herein by reference in their entireties.

The advertisement system 400, for example, can offer branded content publications that are informative and/or entertaining and that are configured to accept Internet-standard advertisement content as illustrated in FIG. 1B. As shown in FIG. 1B, the advertisement system 400 can be provided as an Internet-based advertisement server system and can include an advertisement content source 410 that communicates with a publication source 414. Publication content 210P provided by the publication source 414 and advertisement content 210A provided by the advertisement content source 410 can be presented to the user 412. The publication content 210P and the advertisement content 210A preferably is provided in an Internet-standard advertisement format and measurements, such the format and measurements set forth by the Interactive Advertising Bureau (IAB), and/or is combined and presented simultaneously to the user 412. The combined publication content 210P and advertisement content 210A can be provided to a content source 310 of the information system 100 for storage and subsequent retrieval.

As desired, the advertisement system 400 can create and/or accumulate an inventory of available advertisement content 210A. The inventory of available advertisement content 210A thereby can comprise a predetermined number of available impressions 630 (shown in FIG. 5B) that can be sold, stored via the advertisement content source 410, and/or presented via the information system 100. For instance, the inventory of available advertisement content 210A can be provided as a function of a number of advertisement placements on each page of a selected branded content publication, a number of pages of the branded content publication that can accept the advertisement content 210A, a refresh rate for presenting the advertisement content 210A on each page, and a rate by which the advertisement content 210A is viewed by a selected audience of system users 412. The advertisement system 400 thereby can consolidate and grow the accessible audience of system users 412 by offering operators of the information systems 100, such as arcade operators and/or vehicle operators, branded content publications and/or a share of any advertisement revenue.

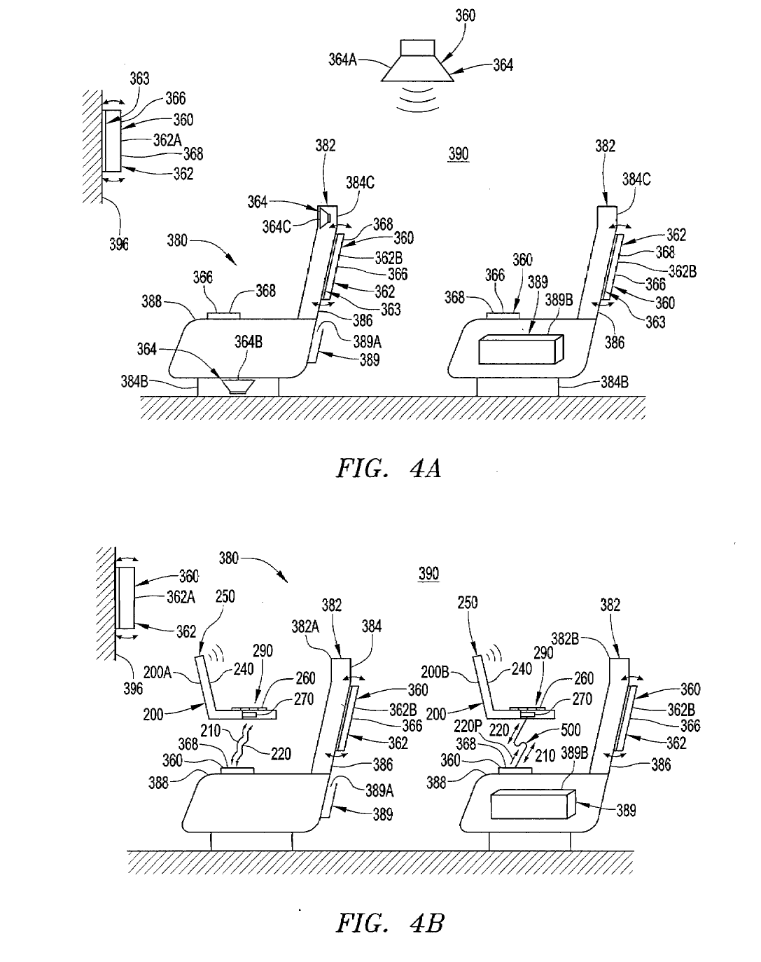

When in communication with the advertisement content source 410, the information system 100 supports two-way communications with the advertisement content source 410. The information system 100, for example, can exchange viewing content 210 (shown in FIGS. 2A-B), including the advertisement content 210A, with the advertisement content source 410. The advertisement content 210A can include audio viewing content and/or video viewing content and can be communicated (or downloaded) from the advertisement content source 410 to the information system 100 for presentation via a video presentation system 362 (shown in FIGS. 4A-B) and/or an audio presentation system 364 (shown in FIGS. 4A-B) of the information system 100. User interaction to the advertisement content 210A likewise can be can be communicated (or uploaded) to the advertisement content source 410 from the information system 100, as desired.

The advertising content 210A can comprise any conventional type of audio and/or video viewing content 210 in the above-referenced co-pending U.S. patent applications, entitled “SYSTEM AND METHOD FOR DOWNLOADING FILES,” Ser. No. 10/772,565, filed on Feb. 4, 2004; entitled “PORTABLE MEDIA DEVICE AND METHOD FOR PRESENTING VIEWING CONTENT DURING TRAVEL,” Ser. No. 11/154,749, filed on Jun. 15, 2005; and entitled “SYSTEM AND METHOD FOR RECEIVING BROADCAST CONTENT ON A MOBILE PLATFORM DURING INTERNATIONAL TRAVEL,” Ser. No. 11/269,378, filed on Nov. 7, 2005. Exemplary viewing content 210 can include television programming content, music content, podcast content, photograph album content, audiobook content, and/or movie content without limitation.

As desired, the viewing content 210 can include geographical information in the manner set forth in U.S. Pat. No. 6,661,353, entitled “METHOD FOR DISPLAYING INTERACTIVE FLIGHT MAP INFORMATION,” which is assigned to the assignee of the present application and the disclosure of which is hereby incorporated herein by reference in its entirety. Alternatively, and/or additionally, to entertainment content, such as live satellite television programming and/or live satellite radio programming, the viewing content likewise can include two-way communications, such as real-time access to the Internet 310C (shown in FIG. 2B) and/or telecommunications in the manner set forth in U.S. Pat. No. 5,568,484, entitled “TELECOMMUNICATIONS SYSTEM AND METHOD FOR USE ON COMMERCIAL AIRCRAFT AND OTHER VEHICLES,” which is assigned to the assignee of the present application and the disclosure of which is hereby incorporated herein by reference in its entirety. It is understood that the exemplary viewing content as shown and described herein are not exhaustive and are provided herein for purposes of illustration only and not for purposes of limitation.

Although the information system 100 can be disposed in a fixed location, such as a building, the information system 100 likewise can advantageously be applied in portable system applications. Turning to FIGS. 2A-B, the information system 100 is shown as comprising a vehicle information system 300 that can be configured for installation aboard a wide variety of vehicles 390. Exemplary types of vehicles can include an automobile 390A (shown in FIG. 2A), an aircraft 390B (shown in FIG. 2B), a bus, a recreational vehicle, a boat, and/or a locomotive, or any other type of passenger vehicle without limitation. If installed on an aircraft 390B as illustrated in FIG. 2B, for example, the vehicle information system 300 can comprise a conventional aircraft passenger in-flight entertainment system, such as the Series 2000, 3000, eFX, and/or eX2 in-flight entertainment system as manufactured by Panasonic Avionics Corporation (formerly known as Matsushita Avionics Systems Corporation) of Lake Forest, Calif.

As shown in FIGS. 2A-B, the vehicle information system 300 comprises at least one conventional content source 310 and one or more user (or passenger) interface systems 360 that communicate via a real-time content distribution system 320. Each content source 310 can be provided in the manner set forth in the above-referenced co-pending U.S. patent applications “SYSTEM AND METHOD FOR DOWNLOADING FILES,” Ser. No. 10/772,565, filed on Feb. 4, 2004; entitled “SYSTEM AND METHOD FOR MANAGING CONTENT ON MOBILE PLATFORMS,” Ser. No. 11/123,327, filed on May 6, 2005; entitled “PORTABLE MEDIA DEVICE AND METHOD FOR PRESENTING VIEWING CONTENT DURING TRAVEL,” Ser. No. 11/154,749, filed on Jun. 15, 2005; and entitled “SYSTEM AND METHOD FOR RECEIVING BROADCAST CONTENT ON A MOBILE PLATFORM DURING INTERNATIONAL TRAVEL,” Ser. No. 11/269,378, filed on Nov. 7, 2005; entitled “SYSTEM AND METHOD FOR INTERFACING A PORTABLE MEDIA DEVICE WITH A VEHICLE INFORMATION SYSTEM,” Ser. No. 12/210,624, filed on Sep. 15, 2008; and “PORTABLE USER CONTROL DEVICE AND METHOD FOR VEHICLE INFORMATION SYSTEMS,” Ser. No. 12/210,689, filed on Sep. 15, 2008.

The content sources 310 can include one or more internal content sources, such as server system 310A, that are installed aboard the vehicle 390 and/or remote (or terrestrial) content sources 310B that can be external from the vehicle 390. The server system 310A can be provided as an information system controller for providing overall system control functions for the vehicle information system 300 and/or at least one media (or file) server system, as illustrated in FIGS. 2A-B), for storing preprogrammed content and/or downloaded viewing content 210D, as desired. The server system 310A can include, and/or communicate with, one or more conventional peripheral media storage systems (not shown), including optical media devices, such as a digital video disk (DVD) system or a compact disk (CD) system, and/or magnetic media systems, such as a video cassette recorder (VCR) system or a hard disk drive (HDD) system, of any suitable kind, for storing the preprogrammed content and/or the downloaded viewing content 210D.

Being configured to distribute and/or present the viewing content 210 provided by one or more selected content sources 310, such as a advertisement content source 410, the vehicle information system 300 can communicate with the content sources 310 in real time and in any conventional manner, including via wired and/or wireless communications. The vehicle information system 300 and the terrestrial content source 310B, for example, can communicate in any conventional wireless manner, including directly and/or indirectly via an intermediate communication system 370, such as a satellite communication system 370A. The vehicle information system 300 thereby can receive download viewing content 210D from a selected terrestrial content source 310B and/or transmit upload viewing content 210U, including navigation and other control instructions, to the terrestrial content source 310B. As desired, the terrestrial content source 310B can be configured to communicate with other terrestrial content sources (not shown). The terrestrial content source 310B is shown in FIG. 2B as providing access to the Internet 310C. Although shown and described as comprising the satellite communication system 370A for purposes of illustration, it is understood that the communication system 370 can comprise any conventional type of wireless communication system, such as a cellular communication system (not shown) and/or an Aircraft Ground Information System (AGIS) communication system (not shown).

To facilitate communications with the terrestrial content sources 310B, the vehicle information system 300 can include an antenna system 330 and a transceiver system 340 for receiving the viewing content from the remote (or terrestrial) content sources 310B as shown in FIGS. 2A-B. The antenna system 330 preferably is disposed outside the vehicle 390, such as an exterior surface 394 of a fuselage 392 of the aircraft 390B. The antenna system 330 can receive viewing content 210 from the terrestrial content source 310B and provide the received viewing content 210, as processed by the transceiver system 340, to a computer system 350 of the vehicle information system 300. The computer system 350 can provide the received viewing content 210 to the media (or content) server system 310A and/or to one or more of the user interfaces 360, as desired. Although shown and described as being separate systems for purposes of illustration, the computer system 350 and the media server system 310A can be at least partially integrated.

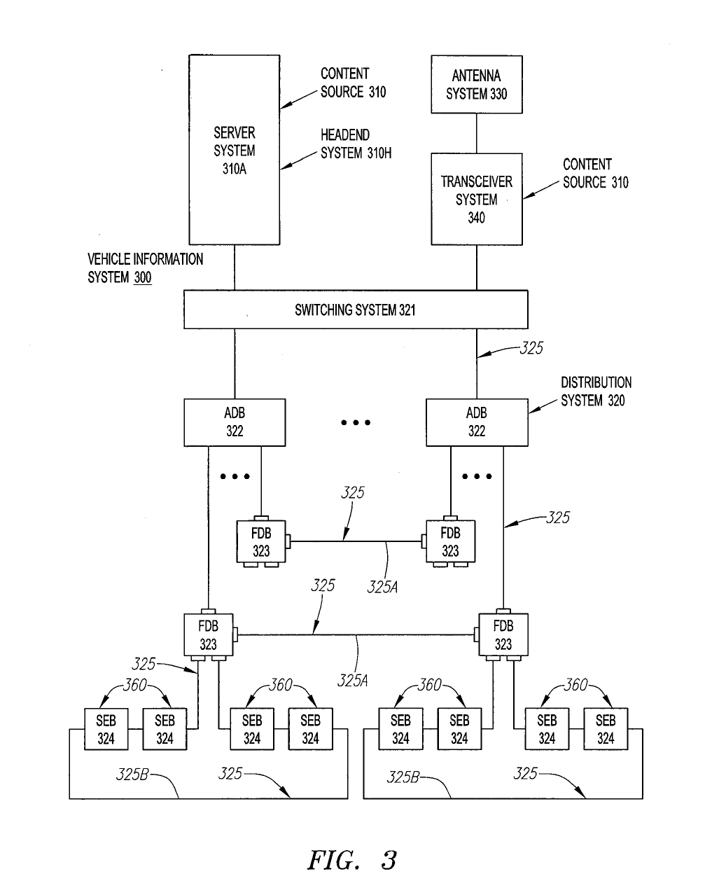

The vehicle information system elements, including the content sources 310 and the user interface systems 360, are shown in FIGS. 2A-B as communicating via the content distribution system 320. FIG. 3 illustrates an exemplary content distribution system 320 for the vehicle information system 300. The content distribution system 320 of FIG. 3 couples, and supports communication between a headend system 310H, which includes the content sources 310, and the plurality of user interface systems 360. The distribution system 320 as shown in FIG. 3 is provided in the manner set forth co-pending U.S. patent application, entitled “SYSTEM AND METHOD FOR ROUTING COMMUNICATION SIGNALS VIA A DATA DISTRIBUTION NETWORK,” Ser. No. 11/277,896, filed on Mar. 29, 2006, and in U.S. Pat. Nos. 5,596,647, 5,617,331, and 5,953,429, each entitled “INTEGRATED VIDEO AND AUDIO SIGNAL DISTRIBUTION SYSTEM AND METHOD FOR USE ON COMMERCIAL AIRCRAFT AND OTHER VEHICLES,” which are assigned to the assignee of the present application and the respective disclosures of which are hereby incorporated herein by reference in their entireties.

The content distribution system 320, for example, can be provided as a conventional wired and/or wireless communication network, including a telephone network, a local area network (LAN), a wide area network (WAN), a campus area network (CAN), personal area network (PAN) and/or a wireless local area network (WLAN), of any kind. Exemplary wireless local area networks include wireless fidelity (Wi-Fi) networks in accordance with Institute of Electrical and Electronics Engineers (IEEE) Standard 802.11 and/or wireless metropolitan-area networks (MANs), which also are known as WiMax Wireless Broadband, in accordance with IEEE Standard 802.16. Preferably being configured to support high data transfer rates, the content distribution system 320 preferably comprises a high-speed Ethernet network, such as any type of Fast Ethernet (such as 100Base-X and/or 100Base-T) communication network and/or Gigabit (such as 1000Base-X and/or 1000Base-T) Ethernet communication network, with a typical data transfer rate of at least approximately one hundred megabits per second (100 Mbps). To achieve high data transfer rates in a wireless communications environment, free-space optics (or laser) technology, millimeter wave (or microwave) technology, and/or Ultra-Wideband (UWB) technology can be utilized to support communications among the various system resources, as desired.

As desired, the distribution system 320 likewise can include a network management system (not shown) provided in the manner set forth in co-pending U.S. patent applications, entitled “SYSTEM AND METHOD FOR IMPROVING NETWORK RELIABILITY,” Ser. No. 10/773,523, filed on Feb. 6, 2004, and entitled “SYSTEM AND METHOD FOR IMPROVING NETWORK RELIABILITY,” Ser. No. 11/086,510, filed on Mar. 21, 2005, which are assigned to the assignee of the present application and the respective disclosures of which are hereby incorporated herein by reference in their entireties.

As illustrated in FIG. 3, the distribution system 320 can be provided as a plurality of area distribution boxes (ADBs) 322, a plurality of floor disconnect boxes (FDBs) 323, and a plurality of seat electronics boxes (SEBs) (and/or premium seat electronics boxes (PSEBs)) 324 being configured to communicate in real time via a plurality of wired and/or wireless communication connections 325. The distribution system 320 likewise can include a switching system 321 for providing an interface between the distribution system 320 and the headend system 310H. The switching system 321 can comprise a conventional switching system, such as an Ethernet switching system, and is configured to couple the headend system 310H with the area distribution boxes 322. Each of the area distribution boxes 322 is coupled with, and communicates with, the switching system 321.

Each of the area distribution boxes 322, in turn, is coupled with, and communicates with, at least one floor disconnect box 323. Although the area distribution boxes 322 and the associated floor disconnect boxes 323 can be coupled in any conventional configuration, the associated floor disconnect boxes 323 preferably are disposed in a star network topology about a central area distribution box 322 as illustrated in FIG. 3. Each floor disconnect box 323 is coupled with, and services, a plurality of daisy-chains of seat electronics boxes 324. The seat electronics boxes 324, in turn, are configured to communicate with the user interface systems 360. Each seat electronics box 324 can support one or more of the user interface systems 360.

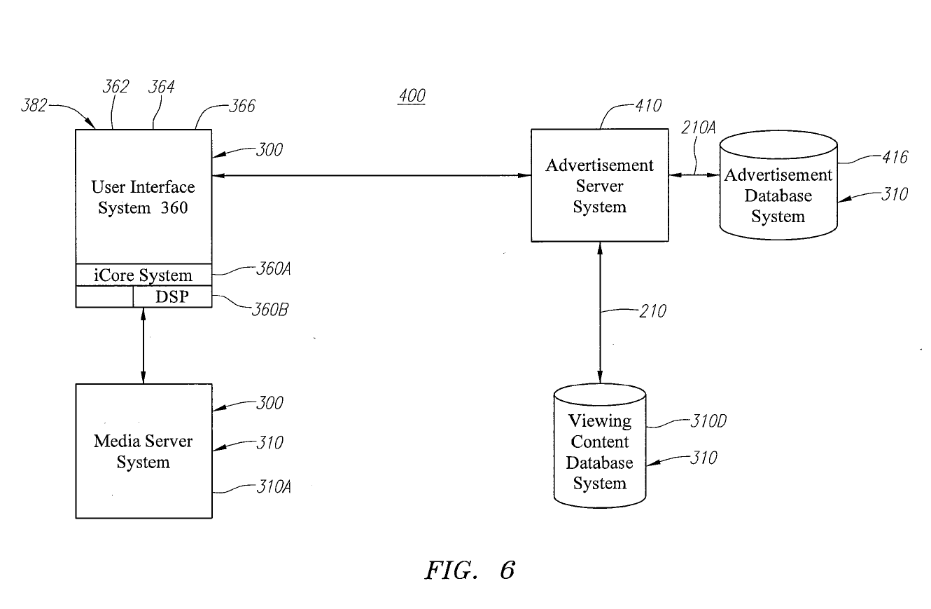

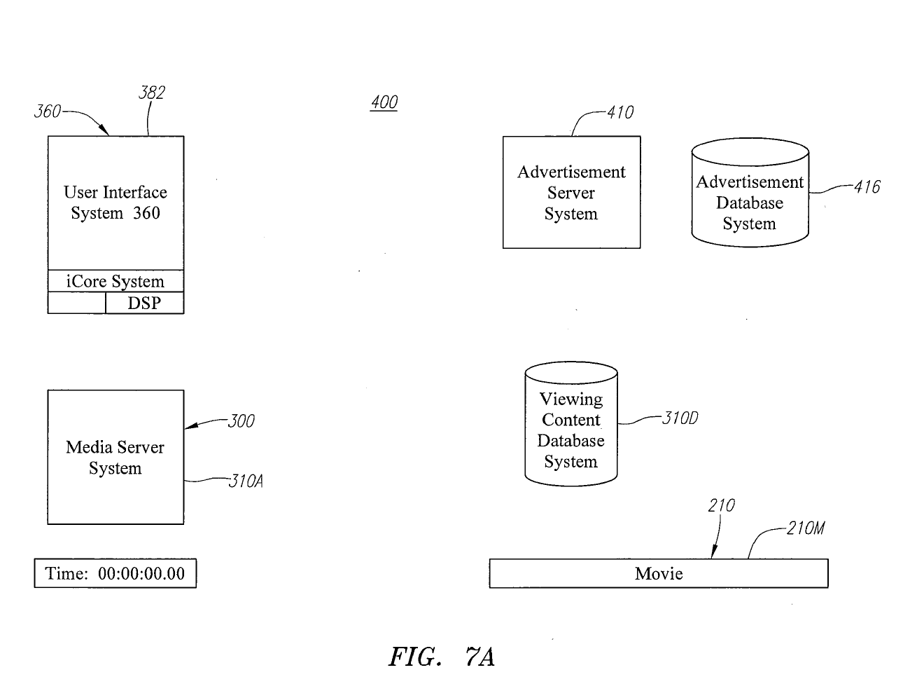

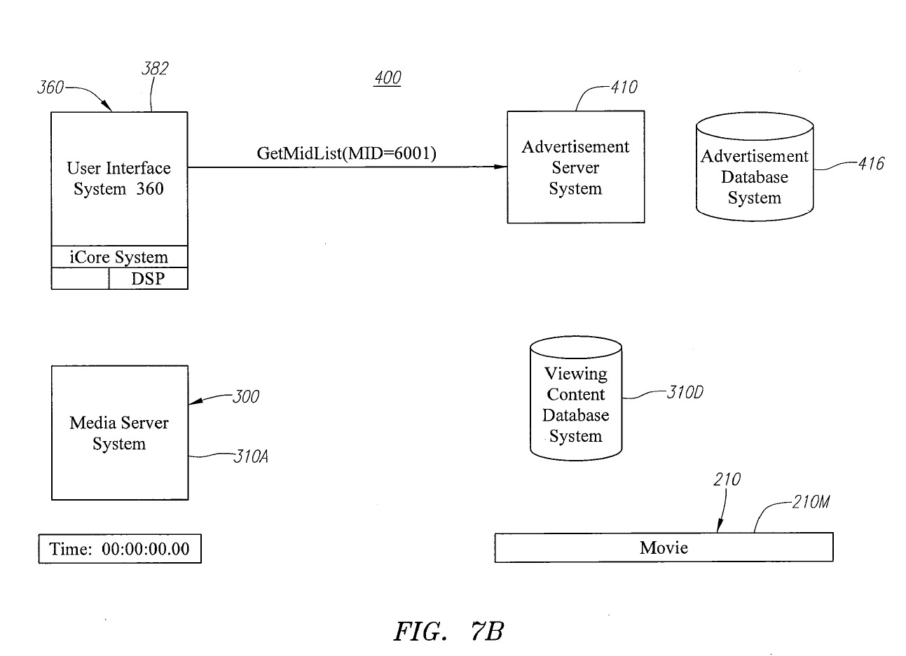

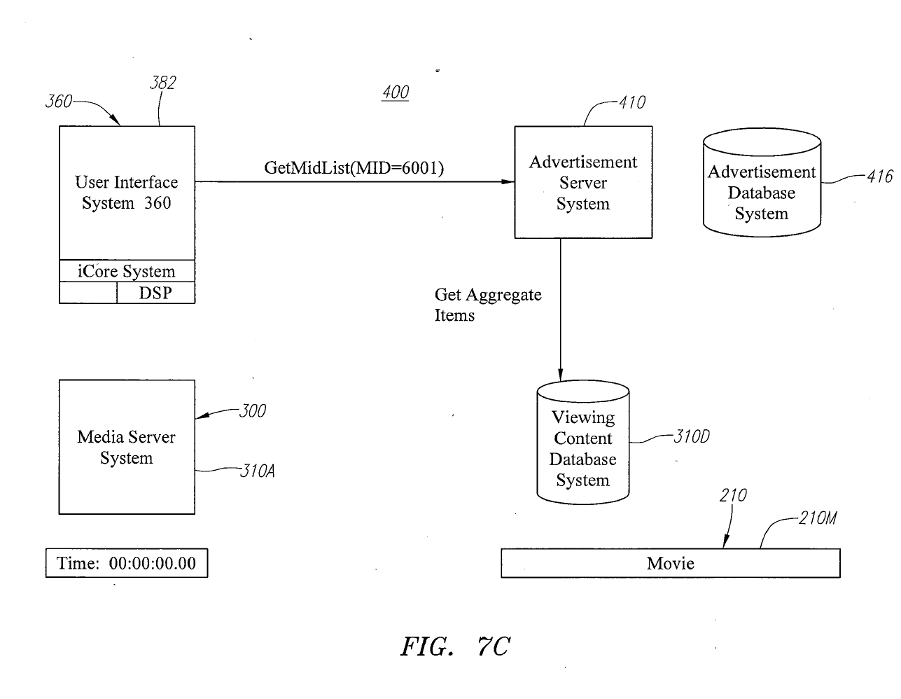

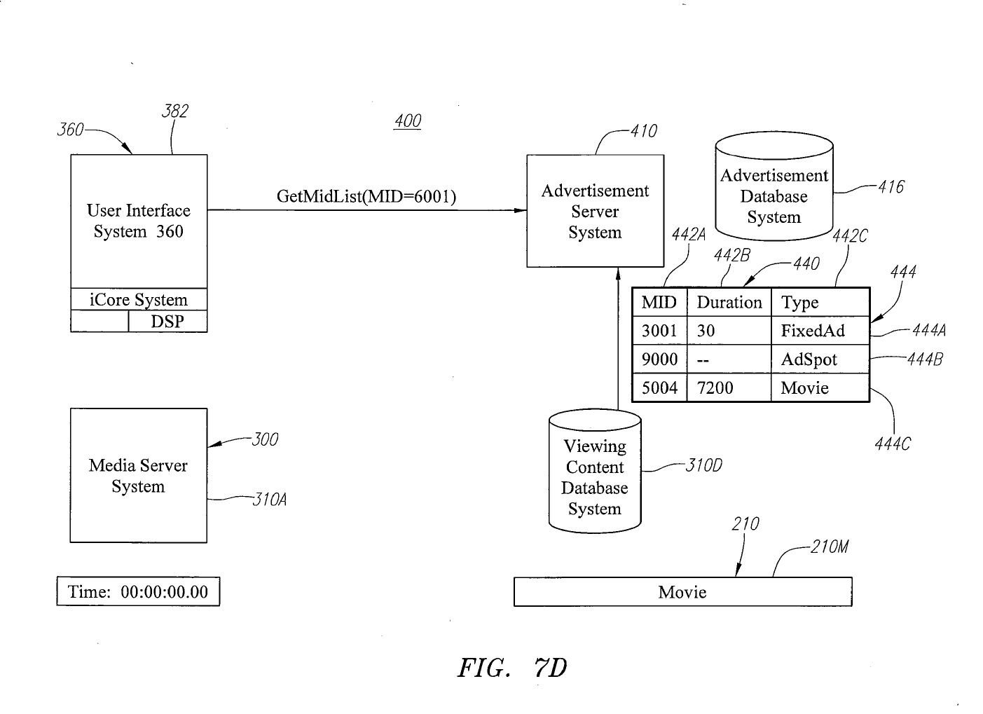

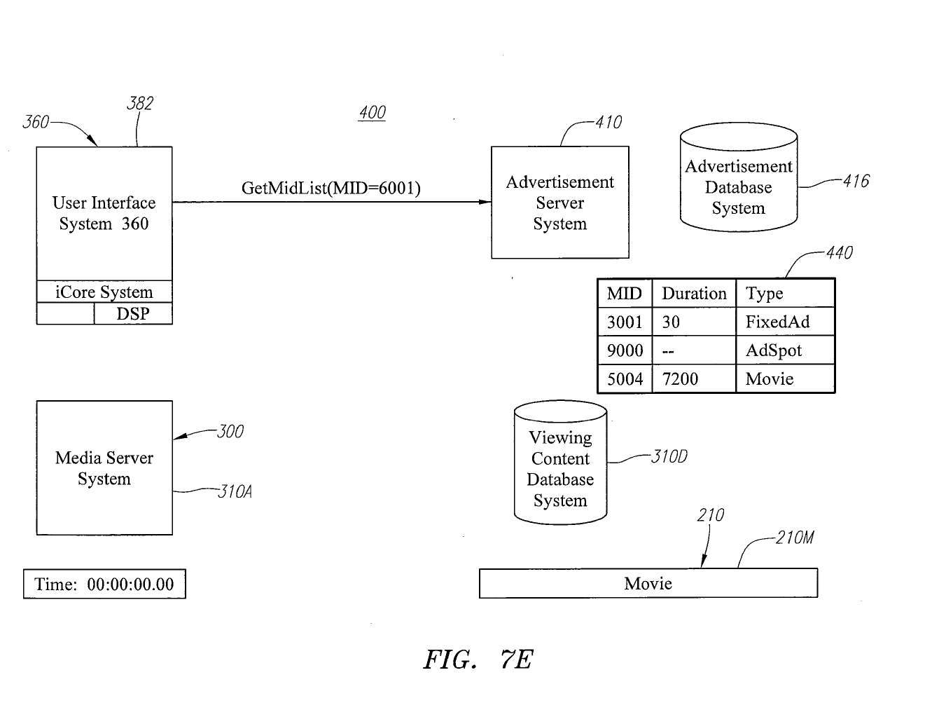

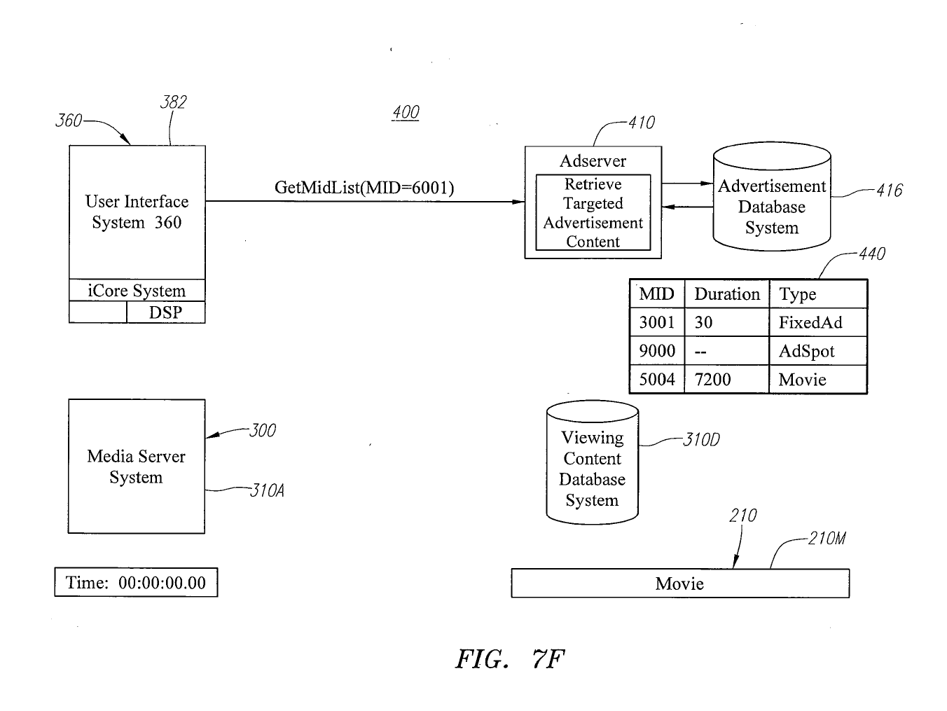

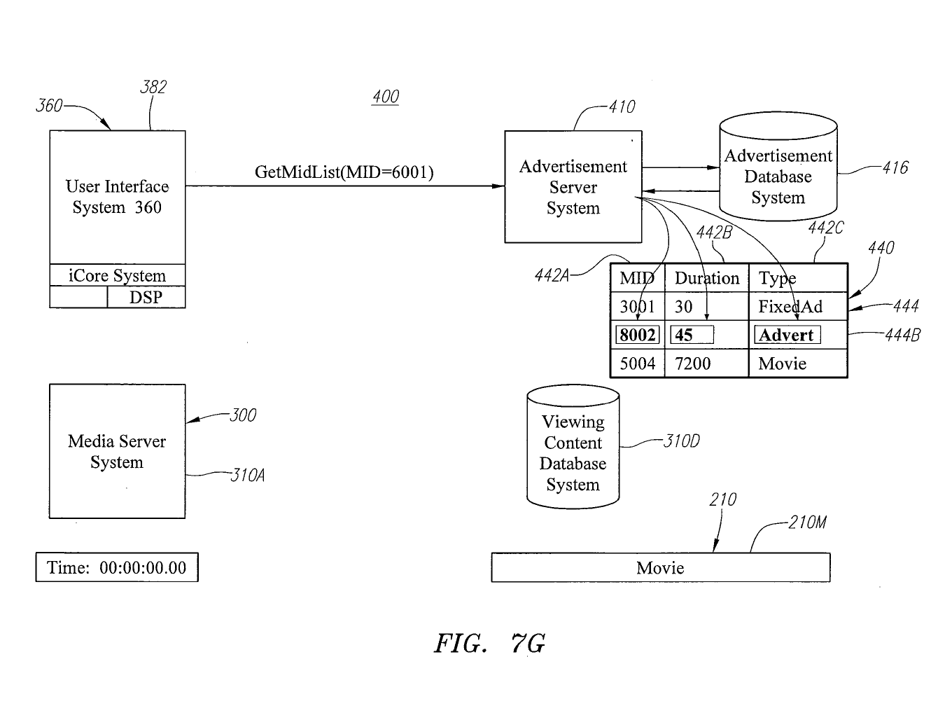

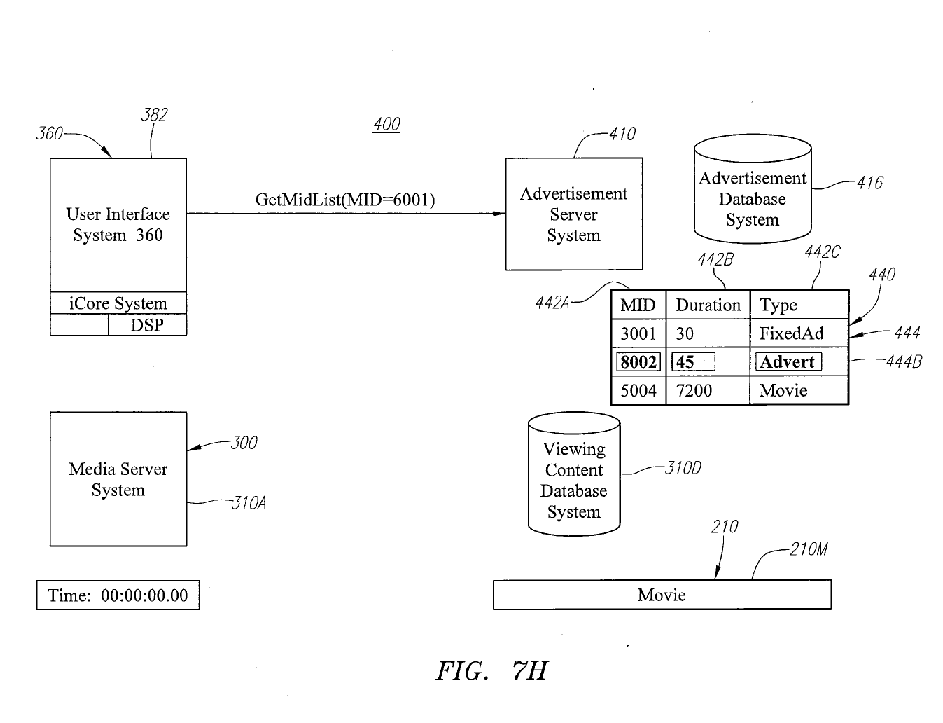

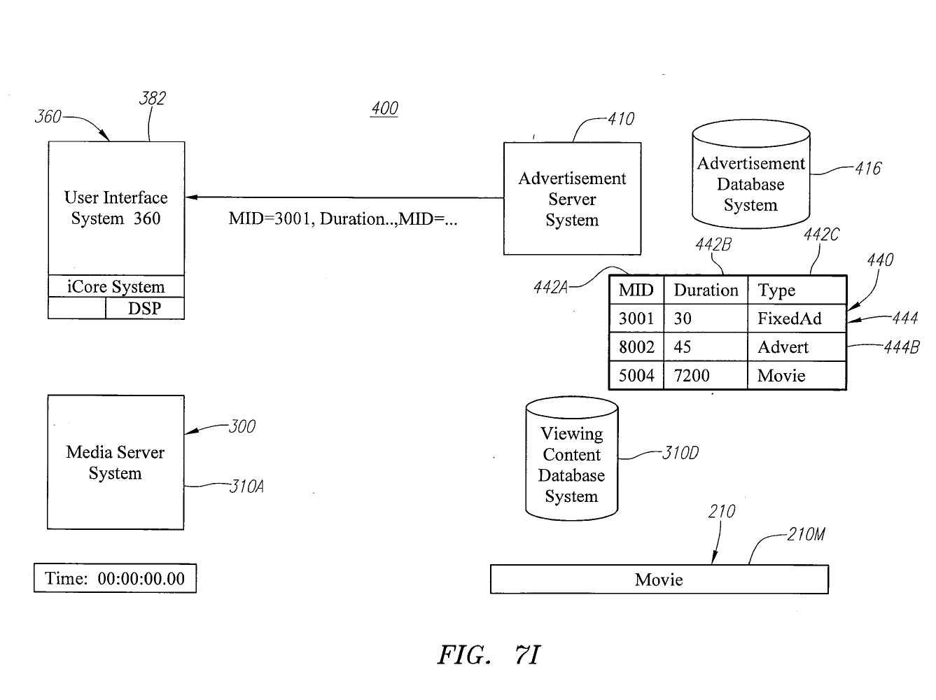

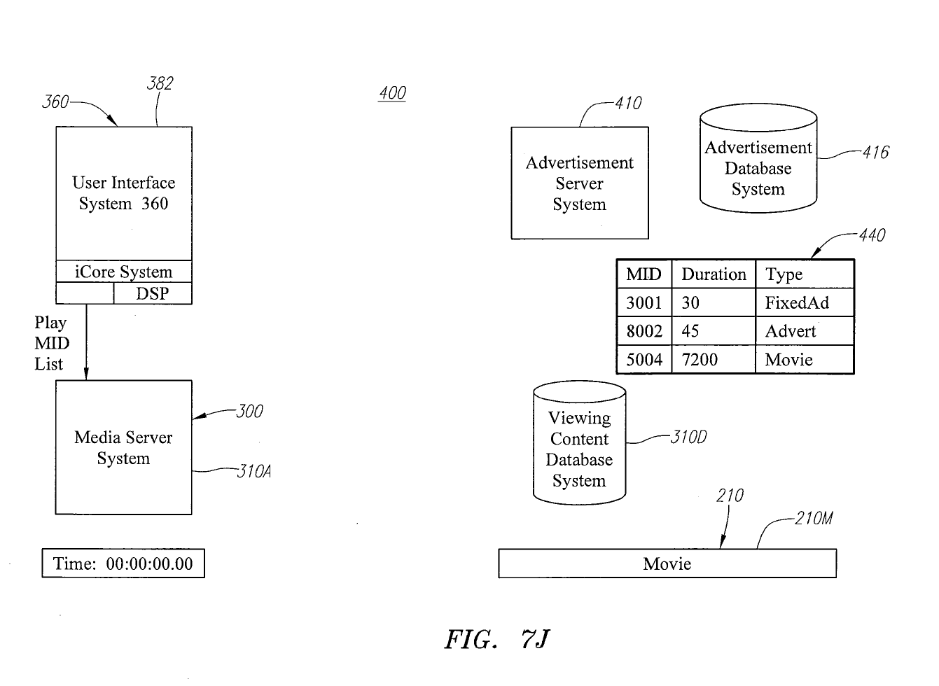

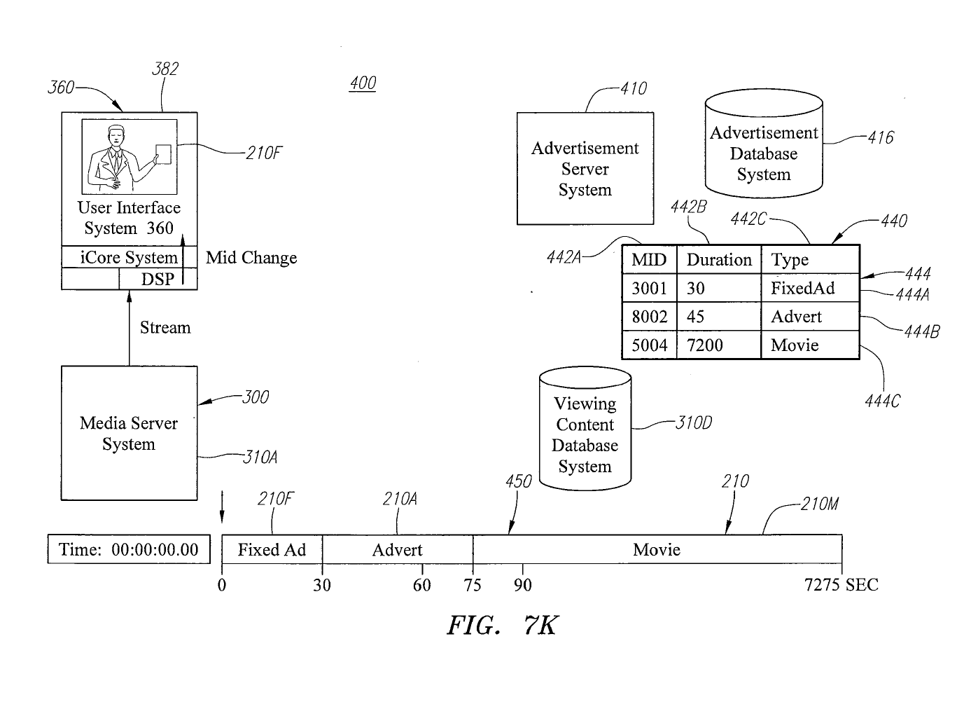

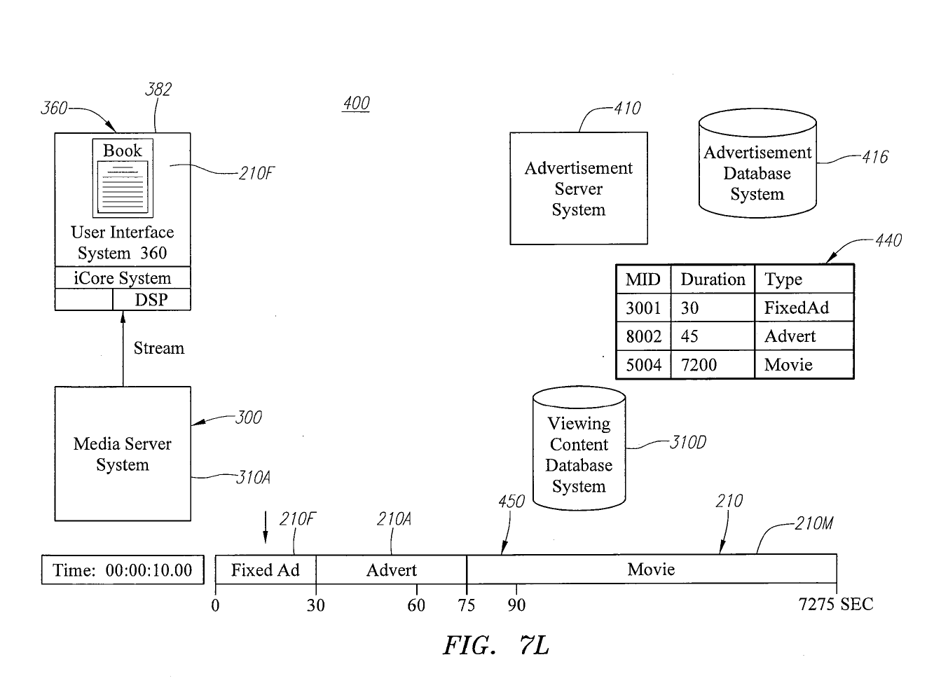

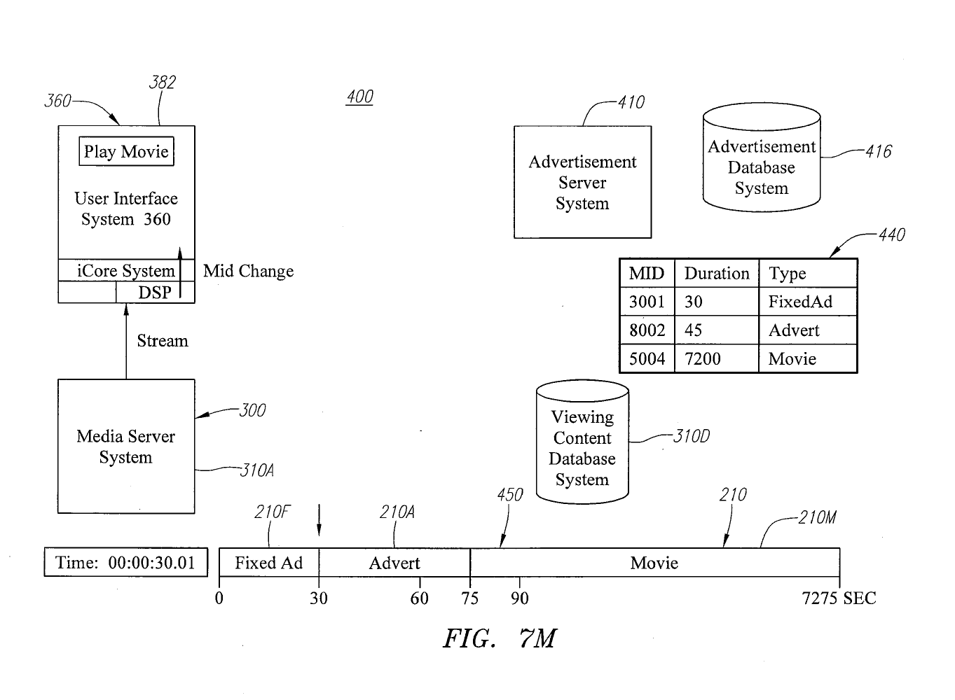

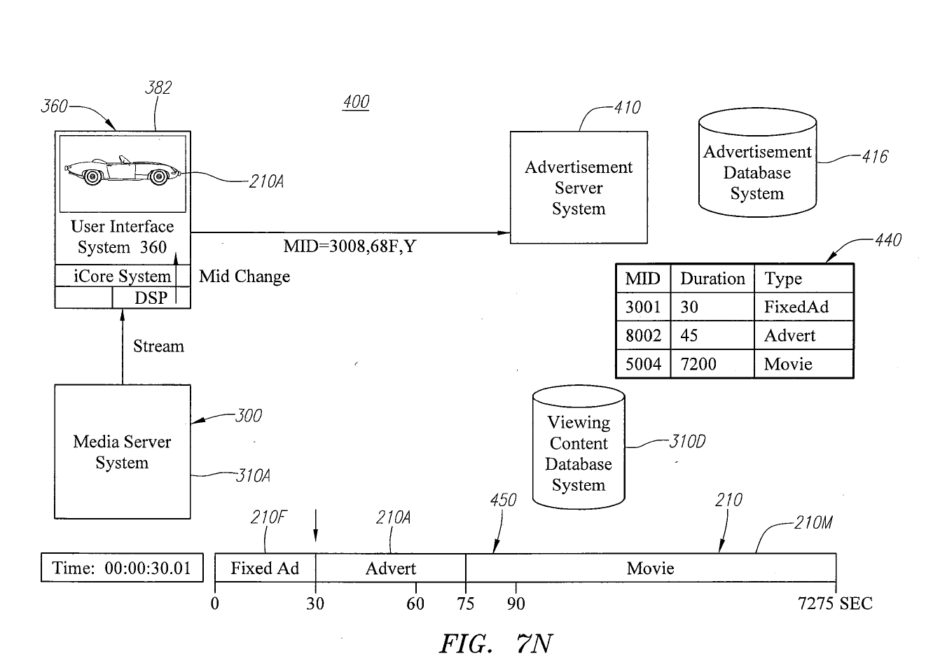

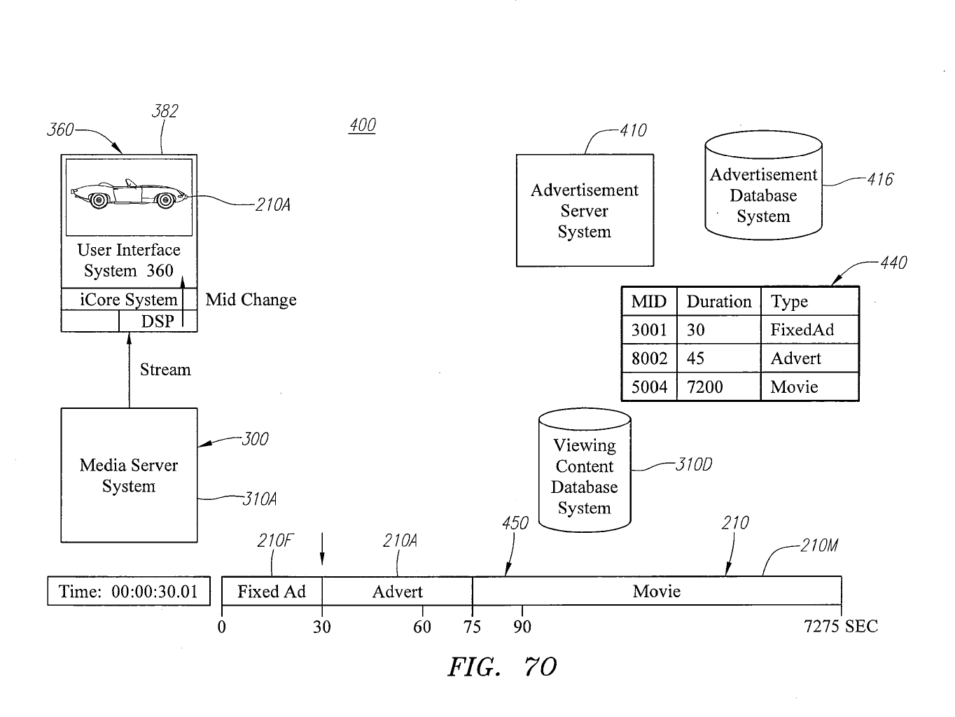

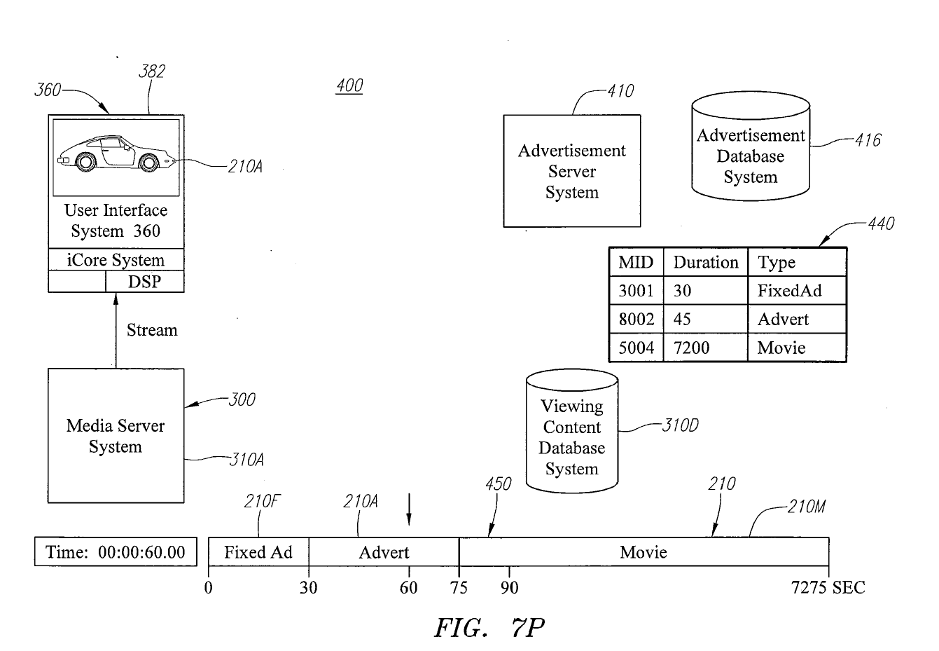

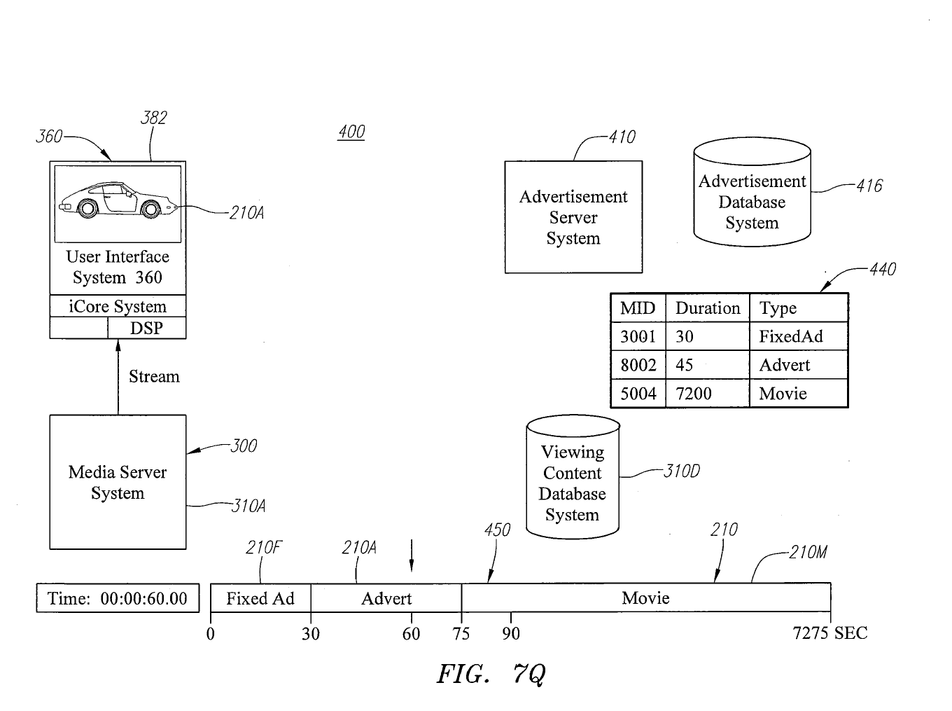

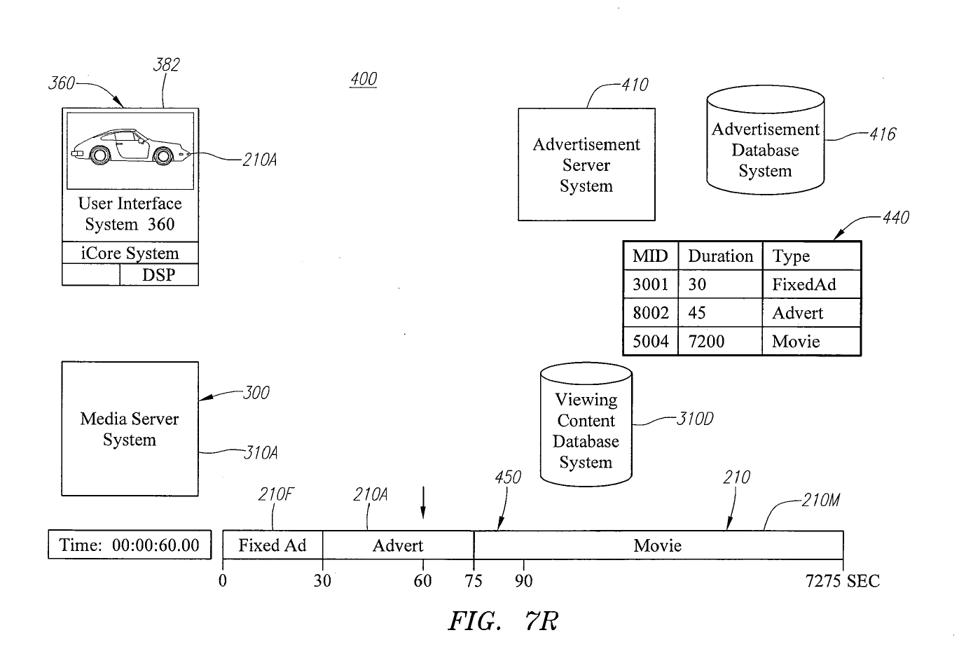

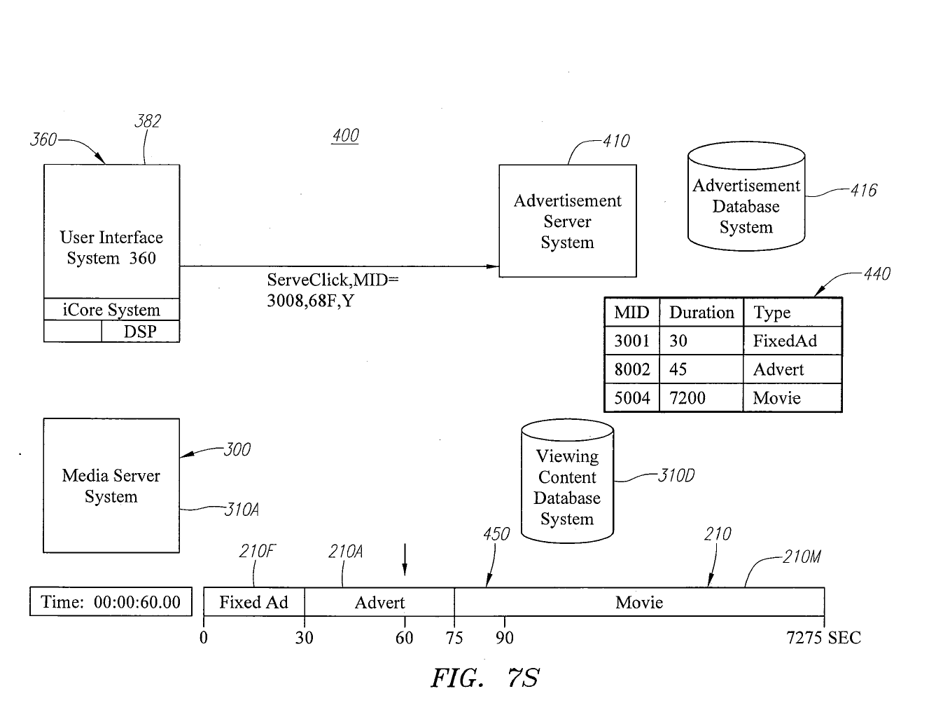

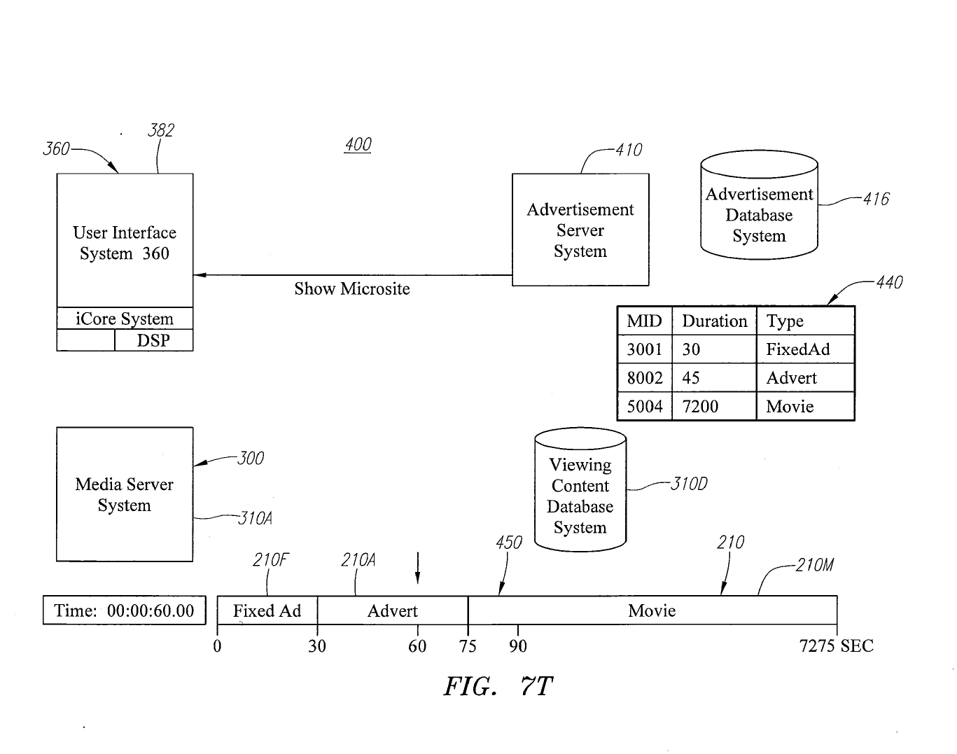

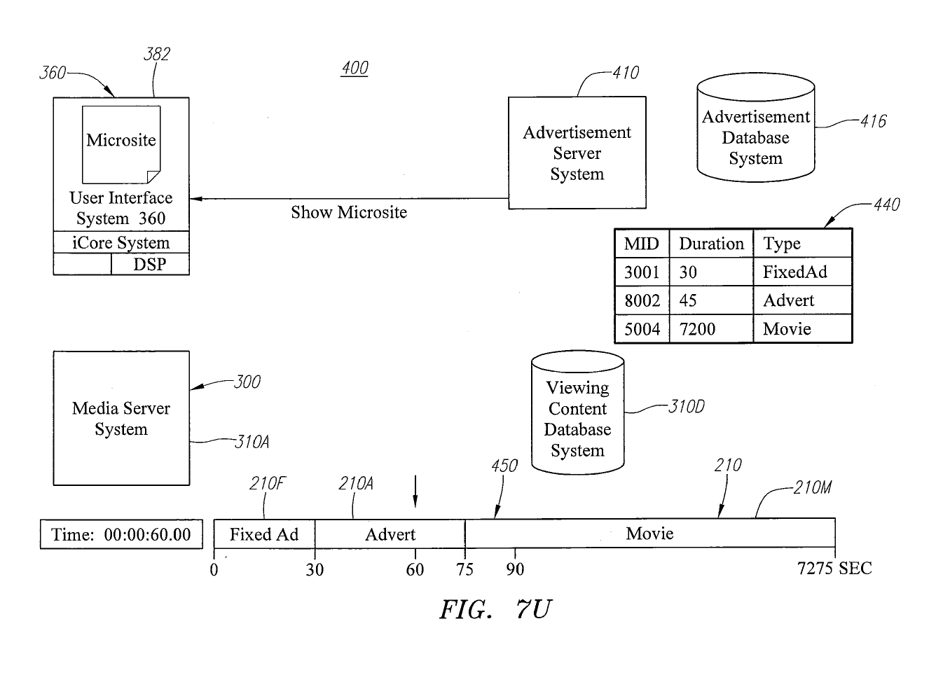

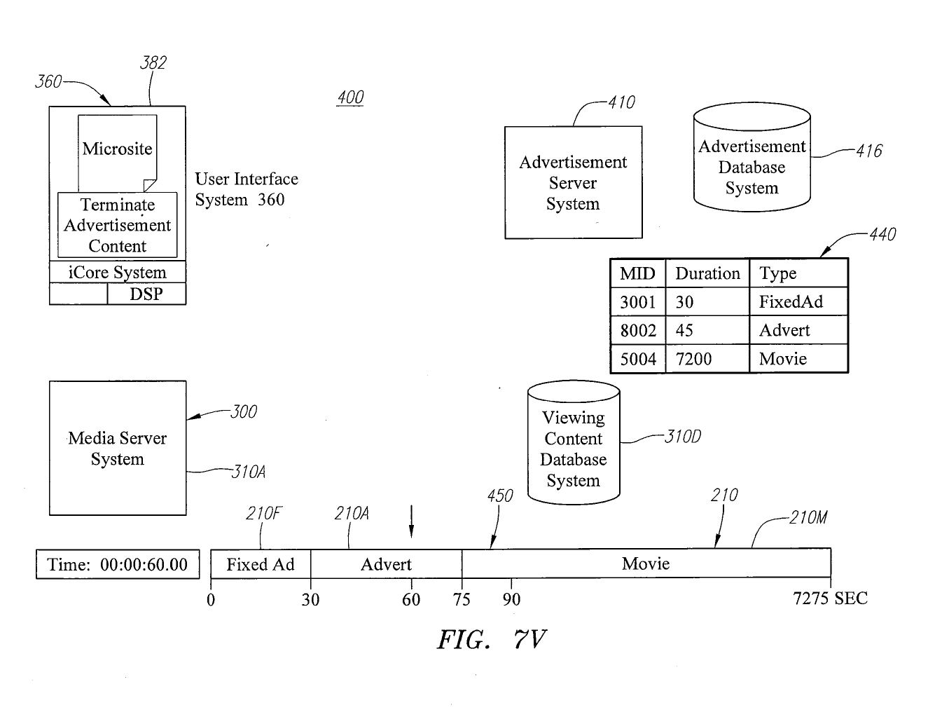

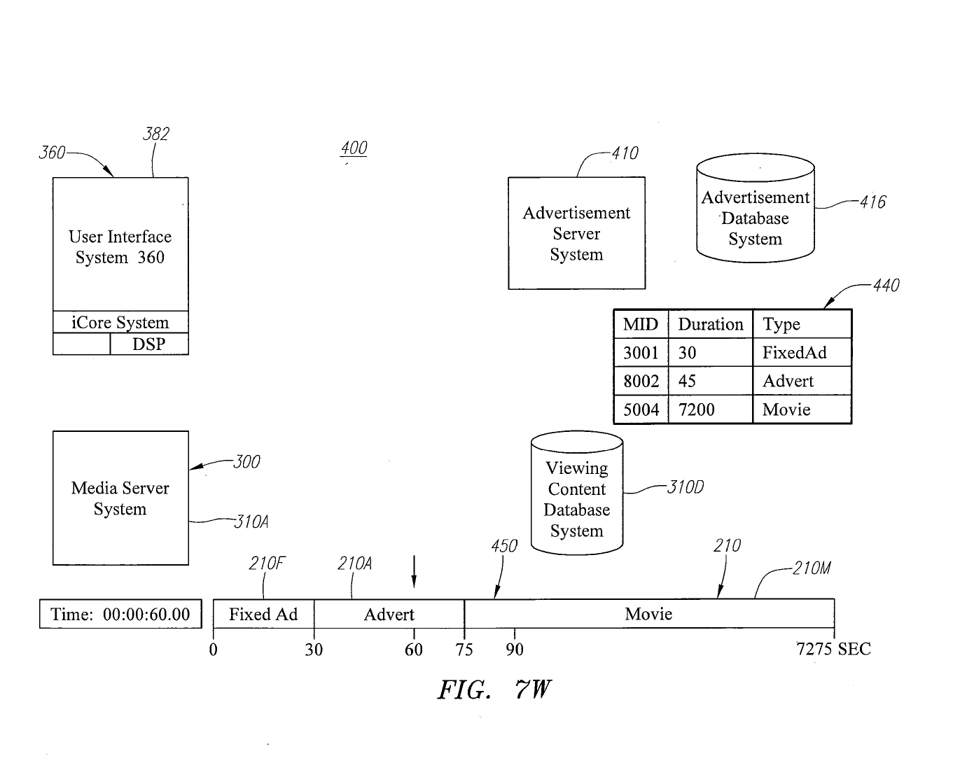

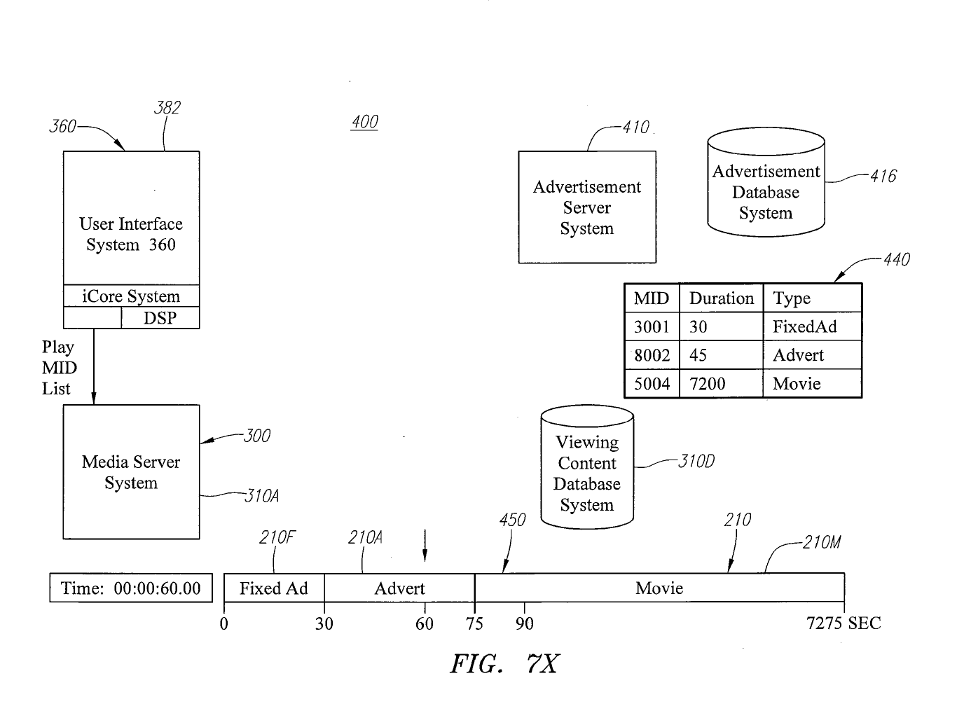

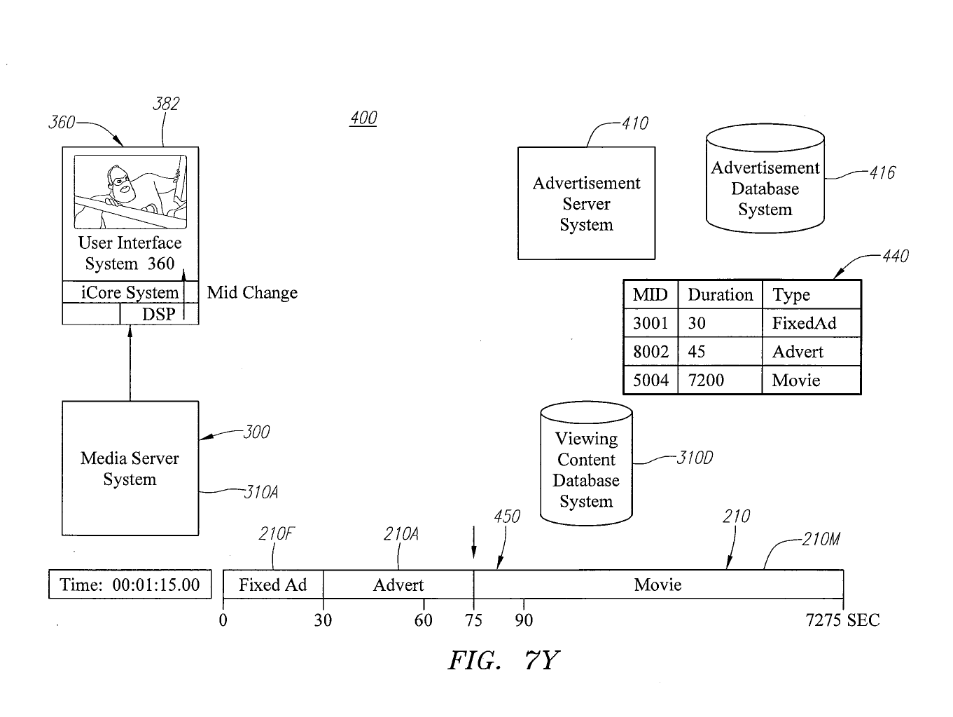

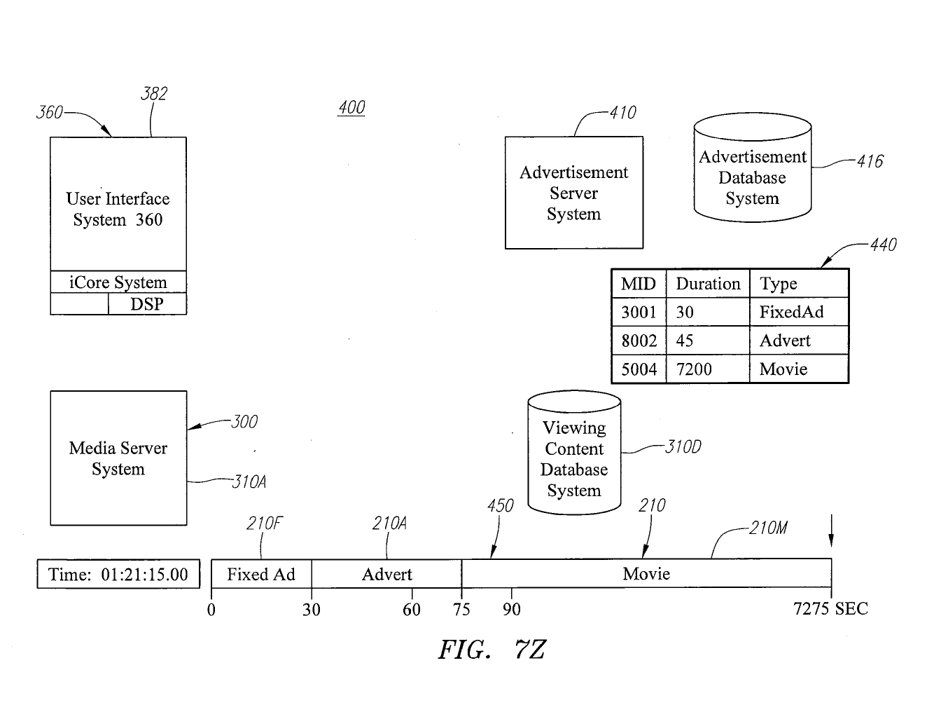

The switching systems 321, the area distribution boxes (ADBs) 322, the floor disconnect boxes (FDBs) 323, the seat electronics boxes (SEBs) (and/or premium seat electronics boxes (PSEBs)) 324, and other system resources of the content distribution system 320 preferably are provided as line replaceable units (LRUs) (not shown). Exemplary other system resources of the content distribution system 320 can include a broadband antenna system 512, a broadband control system 514 (shown in FIG. 6), a wireless access point 368 (shown in FIG. 6), a crew terminal (or panel) 524 (shown in FIGS. 7A-C), an aircraft interface system 522 (shown in FIG. 6), and/or a system controller 530 (shown in FIG. 7B). The use of LRUs facilitate maintenance of the vehicle information system 300 because a defective LRU can simply be removed from the vehicle information system 300 and replaced with a new (or different) LRU. The defective LRU thereafter can be repaired for subsequent installation. Advantageously, the use of LRUs can promote flexibility in configuring the content distribution system 320 by permitting ready modification of the number, arrangement, and/or configuration of the system resources of the content distribution system 320. The content distribution system 320 likewise can be readily upgraded by replacing any obsolete LRUs with new LRUs.

As desired, the floor disconnect boxes (FDBs) 323 advantageously can be provided as routing systems and/or interconnected in the manner set forth in the above-referenced co-pending U.S. patent application, entitled “SYSTEM AND METHOD FOR ROUTING COMMUNICATION SIGNALS VIA A DATA DISTRIBUTION NETWORK,” Ser. No. 11/277,896, filed on Mar. 29, 2006. The distribution system 320 can include at least one FDB internal port bypass connection 325A and/or at least one SEB loopback connection 325B. Each FDB internal port bypass connection 325A is a communication connection 325 that permits floor disconnect boxes 323 associated with different area distribution boxes 322 to directly communicate. Each SEB loopback connection 325B is a communication connection 325 that directly couples the last seat electronics box 324 in each daisy-chain of seat electronics boxes 324 for a selected floor disconnect box 323 as shown in FIG. 3. Each SEB loopback connection 325B therefore forms a loopback path among the daisy-chained seat electronics boxes 324 coupled with the relevant floor disconnect box 323.

Returning to FIGS. 2A-B, the user interface systems 360 are provided for selecting viewing content 210 and for presenting the selected viewing content 210. As desired, the user interface systems 360 can comprise conventional passenger interfaces and can be provided in the manner set forth in the above-referenced co-pending U.S. patent application, entitled “PORTABLE MEDIA DEVICE AND METHOD FOR PRESENTING VIEWING CONTENT DURING TRAVEL,” Ser. No. 11/154,749, filed on Jun. 15, 2005, as well as in the manner set forth in the co-pending U.S. patent application, entitled “SYSTEM AND METHOD FOR PRESENTING HIGH-QUALITY VIDEO TO PASSENGERS ON A MOBILE PLATFORM,” Ser. No. 60/673,171, filed on Apr. 19, 2005, the disclosure of which is hereby incorporated herein by reference in its entirety.

FIG. 4A provides a view of a passenger cabin 380 of a passenger vehicle 390, such as the automobile 390A (shown in FIG. 2A) and/or the aircraft 390B (shown in FIG. 2B), aboard which the vehicle information system 300 has been installed. The passenger cabin 380 is illustrated as including a plurality of passenger seats 382, and each passenger seat 382 is associated with a selected user interface system 360. Each user interface system 360 can include a video interface system 362 and/or an audio interface system 364. Exemplary video interface systems 362 can include overhead cabin display systems 362A with central controls, seatback display systems 362B or armrest display systems (not shown) each with individualized controls, crew display panels, and/or handheld presentation systems. The audio interface systems 364 can be provided in any conventional manner, including an overhead speaker system 364A, the handheld presentation systems, and/or headphones coupled with an audio jack provided, for example, at an armrest 388 of the passenger seat 382. A speaker system likewise can be associated with the passenger seat 382, such as a speaker system 364B disposed within a base 384B of the passenger seat 382 and/or a speaker system 364C disposed within a headrest 384C of the passenger seat 382. In a preferred embodiment, the audio interface system 364 can include an optional noise-cancellation system for further improving sound quality produced by the audio interface system 364.

The video interface systems 362 and the audio interface systems 364 can be installed at any suitable cabin surface, such as a seatback 386, wall 396, ceiling, and/or bulkhead, or an armrest 388 of a passenger seat 382 in any conventional manner including via a mounting system 363 provided in the manner set forth co-pending U.S. patent applications, entitled “SYSTEM AND METHOD FOR MOUNTING USER INTERFACE DEVICES,” Ser. No. 11/828,193, filed on Jul. 25, 2007, and entitled “USER INTERFACE DEVICE AND METHOD FOR PRESENTING VIEWING CONTENT,” Ser. No. 11/835,371, filed on Aug. 7, 2007, which are assigned to the assignee of the present application and the respective disclosures of which are hereby incorporated herein by reference in their entireties.

As shown in FIG. 4A, the user interface system 360 likewise can include a user input system 366 for permitting the user (or passenger) to communicate with the vehicle information system 300, such as via an exchange of control signals 220. For example, the user input system 366 can permit the user to enter one or more user instructions 230 for controlling the operation of the vehicle information system 300. Illustrative user instructions 230 can include instructions for initiating communication with the content source 310, instructions for selecting viewing content 210 for presentation, and/or instructions for controlling the presentation of the selected viewing content 210. If a fee is required for accessing the viewing content 210, payment information likewise can be entered via the user input system 366.

The user input system 366 can be provided in any conventional manner and typically includes one or more switches (or pushbuttons), such as a keyboard or a keypad, and/or a pointing device, such as a mouse, trackball, or stylus. As desired, the user input system 366 can be at least partially integrated with, and/or separable from, the associated video interface system 362 and/or audio interface system 364. For example, the video interface system 362 and the user input system 366 can be provided as a touchscreen display system. The user input system 366 likewise can include one or more input ports (not shown) for coupling a peripheral input device (not shown), such as a full-size computer keyboard, an external mouse, and/or a game pad, with the vehicle information system 300.

Preferably, at least one of the user interface systems 360 includes a wired and/or wireless access point 368, such as a conventional communication port (or connector), for coupling a personal media device 200 (shown in FIG. 4B) with the vehicle information system 300. Passengers (or users) 412 (shown in FIG. 5A) who are traveling aboard the vehicle 390 thereby can enjoy personally-selected viewing content during travel. The access point 368 is located proximally to an associated passenger seat 382 and can be provided at any suitable cabin surface, such as a seatback 386, wall 396, ceiling, and/or bulkhead.

Turning to FIG. 4B, the vehicle information system 300 is shown as communicating with one or more personal media devices 200. Each personal media device 200 can store the audio and/or video viewing content 210 and can be provided as a handheld device, such as a laptop computer, a palmtop computer, a personal digital assistant (PDA), cellular telephone, an iPod® digital electronic media device, an iPhone® digital electronic media device, and/or a MPEG Audio Layer 3 (MP3) device. Illustrative personal media devices 200 are shown and described in the co-pending U.S. patent applications, entitled “SYSTEM AND METHOD FOR DOWNLOADING FILES,” Ser. No. 10/772,565, filed on Feb. 4, 2004; entitled “PORTABLE MEDIA DEVICE AND METHOD FOR PRESENTING VIEWING CONTENT DURING TRAVEL,” Ser. No. 11/154,749, filed on Jun. 15, 2005; and entitled “SYSTEM AND METHOD FOR RECEIVING BROADCAST CONTENT ON A MOBILE PLATFORM DURING INTERNATIONAL TRAVEL,” Ser. No. 11/269,378, filed on Nov. 7, 2005; entitled “SYSTEM AND METHOD FOR INTERFACING A PORTABLE MEDIA DEVICE WITH A VEHICLE INFORMATION SYSTEM,” Ser. No. 12/210,624, filed on Sep. 15, 2008; entitled “MEDIA DEVICE INTERFACE SYSTEM AND METHOD FOR VEHICLE INFORMATION SYSTEMS,” Ser. No. 12/210,636, filed on Sep. 15, 2008; entitled “MEDIA DEVICE INTERFACE SYSTEM AND METHOD FOR VEHICLE INFORMATION SYSTEMS,” Ser. No. 12/210,652, filed on Sep. 15, 2008; and “PORTABLE USER CONTROL DEVICE AND METHOD FOR VEHICLE INFORMATION SYSTEMS,” Ser. No. 12/210,689, filed on Sep. 15, 2008, which are assigned to the assignee of the present application and the respective disclosures of which are hereby incorporated herein by reference in their entireties.

The illustrated personal media devices 200 each include a video display system 240 for visually presenting the viewing content 210 and an audio system 250 for audibly presenting the viewing content 210. Each personal media device 200 can include a user control system 260, which can be provided in any conventional manner and typically includes one or more switches (or pushbuttons), such as a keyboard or a keypad, and/or a pointing device, such as a mouse, trackball, or stylus. The personal media devices 200 thereby can select desired viewing content 210 and control the manner in which the selected viewing content 210 is received and/or presented.

The personal media devices 200 likewise include a communication port (or connector) 270. The communication port 270 enables the personal media devices 200 to communicate with the vehicle information system 300 via the access points 368 of the user interface systems 360. As illustrated with personal media device 200A, the communication port 270 and the access points 368 can supported wireless communications; whereas, support for wired communications between the communication port 270 and the access points 368 via a communication cable assembly 500 is shown with personal media device 200B. When the communication port 270 and the access points 368 are in communication, the vehicle information system 300 supports a simple manner for permitting the associated personal media device 200 to be integrated with the vehicle information system 300 using a user-friendly communication interface.

When the personal media device 200 and the vehicle information system 300 are in communication, the vehicle information system 300 can perform a plurality of integration tasks simultaneously, enabling the personal media device 200 to become fully integrated with the vehicle information system 300 via a selected access point 368. The system elements of the vehicle information system 300 and the personal media device 200 thereby become interchangeable. The personal media device 200 likewise can receive control signals (or commands) 220 and/or operating power 220P from the vehicle information system 300. Thereby, the personal media device 200 advantageously can become a seamless part of the vehicle information system 300.

For example, user instructions 230 (shown in FIGS. 2A-B) for controlling the operation of the vehicle information system 300 can be provided via the user input system 366 of the vehicle information system 300 and/or the user control system 260 of the personal media device 200. In other words, the user input system 366 of the vehicle information system 300 and/or the user control system 260 of the personal media device 200 can be used to select viewing content 210 and control the manner in which the selected viewing content 210 is received and/or presented. The selected viewing content 210 can be provided by a relevant content source 310 (shown in FIGS. 2A-B) of the vehicle information system 300 and/or by storage media (not shown) disposed within the personal media device 200. A video portion of the selected viewing content 210 thereby can be presented via the video presentation system 362 of the vehicle information system 300 and/or the video display system 240 of the personal media device 200. The audio presentation system 364 of the vehicle information system 300 and/or the audio system 250 of the personal media device 200 can be used to present an audio portion of the selected viewing content 210. If the video display system 240 of the personal media device 200 is much smaller than the video presentation system 362 of the vehicle information system 300, a passenger may prefer to view the selected viewing content 210 via the larger video presentation system 362.

When no longer in use and/or direct physical contact with the personal media device 200 is not otherwise required, the personal media device 200 can be stored at the passenger seat 382. For example, the passenger seat 382 can include a storage compartment 389 for providing storage of the personal media device 200. The storage compartment 389 can be provided in any conventional manner and at any suitable portion of the passenger seat 382. As illustrated with passenger seat 382B, the personal media device 200 can be placed in a storage pocket 389B formed in the armrest 388 of the passenger seat 382B. The storage compartment 389 likewise can be provided on the seatback 386 and/or the headrest 384 of the passenger seat 382. Storage compartment 389A of passenger seat 382A, for example, is shown as being formed on the lower seatback 386 of the passenger seat 382A. As desired, the storage compartment 389 can comprise an overhead storage compartment, a door storage compartment, a storage compartment provided underneath the passenger seat 382, or any other type of conventional storage compartment, such as a glove compartment, trunk, or closet, available in the passenger vehicle 390.

If the associated with a passenger vehicle 390 (shown in FIGS. 2A-B) such as an aircraft 390B (shown in FIG. 2B), the advertisement system 400 advantageously can be configured for use with an vehicle information system 300 (shown in FIGS. 2A-B) installed aboard the passenger vehicle 390 as illustrated in FIG. 5A. As desired, the advertisement content source 410 can be provided as a media server system 310A that can be can be separate from the vehicle information system 300 (as shown in FIG. 1A) and/or at least partially integrated with the vehicle information system 300 as shown in FIG. 5A. Thereby, the advertisement content source 410 can operate as an advertisement-server system and can present targeted advertisement content 210A to passengers (or users) 412 traveling aboard the aircraft 390B. Use of the advertisement content source 410 as an advertisement-server system facilitates management of one or more advertisement-sales systems (or networks) that intend to provide advertisement content 210A to the passengers 412 traveling aboard the aircraft 390B. The advertisement content source 410, when used as an advertisement-server system, likewise can manage sales and/or trafficking of the advertisement content 210A across one or more airlines at the same time.

As shown in FIG. 5A, the advertisement system 400 can include a terrestrial (or ground-side) portion 400A and an aircraft-based (or air-side) portion 400B. The terrestrial portion 400A of the advertisement system 400 is shown as including an advertisement-serving system 420, such as an advertisement agency and/or publisher advertisement-serving system. The advertisement-serving system 420 can communicate with an advertisement (or local) console 422 and/or can communicate with one or more remote console systems 430 in any conventional manner. Exemplary remote console systems 430 can include an advertisement agency (or brand) console 430A and/or an airline console 430B. The advertisement agency console 430A can provide original advertisement content 210A to the advertisement-serving system 420 for further distribution via the advertisement system 400; whereas, the airline console 430B can provide the advertisement-serving system 420 with passenger, flight, and other information for preselected aircraft 390B and/or flights. As illustrated in FIG. 5A, the advertisement-serving system 420 can communicate with at least one of the remote console systems 430 via the Internet 310C.

The aircraft-based portion 400B of the advertisement system 400 is shown as including the advertisement content source 410 and the vehicle information system 300. In other words, the advertisement content source 410 can be provided as a content server system 310A of the vehicle information system 300. The advertisement content source 410 receives the advertisement content 210A, including targeted advertisement content 210A, from the terrestrial advertisement-serving system 420 and provides user response 210R to the advertisement-serving system 420. The terrestrial portion 400A and the aircraft-based portion 400B of the advertisement system 400 can communicate in the manner set forth in the above-referenced co-pending U.S. patent applications: entitled “SYSTEM AND METHOD FOR ROUTING COMMUNICATION SIGNALS VIA A DATA DISTRIBUTION NETWORK,” Ser. No. 11/277,896, filed on Mar. 29, 2006; entitled “SYSTEM AND METHOD FOR RECEIVING BROADCAST CONTENT ON A MOBILE PLATFORM DURING INTERNATIONAL TRAVEL,” Ser. No. 11/269,378, filed on Nov. 7, 2005; and entitled “SYSTEM AND METHOD FOR RECEIVING BROADCAST CONTENT ON A MOBILE PLATFORM DURING TRAVEL,” application Ser. No. 12/237,253, filed on Sep. 24, 2008.

The advertisement content 210A preferably is filtered based upon a predetermined filtering criteria such that suitable advertisement content 210A is provided to the vehicle information system 300. For example, the advertisement content 210A can be filtered such that the advertisement content 210A includes updated and/or predetermined advertisement content for a preselected aircraft 390B and/or flight segment. The filtered advertisement content 210A thereby can be provided to the vehicle information system 300. As desired, the advertisement content 210A can be at least partially filtered by the advertisement-serving system 420 prior to transmission to the vehicle information system 300, by the advertisement content source 410 after transmission, or by both.

The advertisement content source 410 likewise can select the advertisement content 210A to be presented to each system user (or passenger) 412. Preferably, the advertisement content 210A to be presented to each passenger 412 is filtered (or targeted) based upon a predetermined targeting criteria (or rules) such that targeted advertisement content 210A is provided to each system user 412 traveling aboard the aircraft 390B. An advertisement campaign thereby can be shown to system users 412 that match a specific audience profile that is associated with the predetermined targeting criteria. The predetermined targeting criteria, for example, can be based upon passenger information, passenger seat (or service) class information, flight information, and/or other information and/or can be provided via the airline console 430B. Exemplary flight information can include an origin and/or a destination of the flight. The targeted advertisement content 210A can be uniform and/or different among the passengers 412.

The vehicle information system 300 can present the targeted advertisement content 210A to the passengers 412. In other words, a video portion of the targeted advertisement content 210A can be presented via the video presentation system 362 (shown in FIGS. 4A-B) and/or an audio portion of the targeted advertisement content 210A can be presented via the audio presentation system 364 (shown in FIGS. 4A-B) at the passenger seats 382 (shown in FIGS. 4A-B) of the aircraft 390B. Each passenger 412 can select which, if any, of the targeted advertisement content 210A to view. The effectiveness of the advertisement campaign advantageously can be increased by having the advertisement system 400 present the targeted advertisement content 210A to users (or aircraft passengers) 412. The return on investment (ROI) for such advertisement campaigns likewise can increased if the targeted advertisement content 210A sold based upon presentation of the advertisement impression 630 (shown in FIG. 5B) and/or presentation of the targeted advertisement content 210A.

An exemplary menu system 600 for presenting the targeted advertisement content 210A to the passengers 412 is illustrated in FIG. 5B. The menu system 600 can be presented via the video presentation system 362 of the vehicle information system 300 and can include a logo (or other branding information) 610 of the operator of the aircraft 390B. The menu system 600 is shown as presenting a plurality of menu options 620, such as menu options 620A-H, that are associated with viewing content 210 (shown in FIGS. 2A-B and 4A-B) that can be presented via the vehicle information system 300. Exemplary viewing content 210 that can be associated with the menu options 620 can include movies 620A, television (live and/or time delayed) 620B, music 620C, games 620D, content suitable for children 620E, flight tracking 620F, marketplace content 620G, and/or other viewing content 620H. The menu options 620 likewise can include control options. Menu option 620I, for example, can be used to turn off the video presentation system 362.

The menu system 600 likewise can include at least one advertisement impression 630. The advertisement impression 630 can comprise any conventional advertisement impression, such as a banner advertisement and/or an advertisement button, that can be activated (or selected) by a users (or passengers) 412 (shown in FIG. 5A). When activated, the advertisement impression 630 can enable the vehicle information system 300 to present the associated advertisement content 210A that is available from the advertisement content source 410. Although shown and described as comprising selected menu features for purposes of illustration only, the menu system 600 can be provided in any conventional manner.

Returning briefly to FIG. 5A, the advertisement system 400 can measure the effectiveness of the advertisement content 210A presented to the passengers 412 in the manner discussed above. The advertisement content source 410 can receive a user response 210R as a measure of the effectiveness of the advertisement content 210A. If an advertisement impressions 630 (shown in FIG. 5B) is associated with the targeted advertisement content 210A and the advertisement impression is presented to a selected passenger 412, the passenger 412 can select (and view) the associated advertisement content 210A by activating the advertisement impression. The user response 210R thereby can include a number of advertisement impressions presented by the vehicle information system 300 and/or a number of associated advertisement content 210A selected for viewing. The advertisement content source 410 can compile the user response 210R and can provide the user response 210R to the advertisement-serving system 420. The advertisement-serving system 420, in turn, can provide the user response 210R to the respective advertisement agency consoles 430A in a conventional data format.

As such, use of the vehicle information system 300 can be commercialized, improving advertiser access to passengers 412, while enhancing the passenger experience. The advertisement system 400 thereby can advantageously resolve the fragmentation problems with conventional information systems by aggregating the audience of passengers (or system users) 412 and/or the inventory of the advertisement content 210A. The complexity inherent in conventional information systems can be simplified by advertisement serving tools of the advertisement system 400, wherein the advertisement serving tools can simplify purchases made via the advertisement system 400. The advertisement system 400 likewise can resolve the lack of standards of conventional information systems by adopting existing standards, such as the Interactive Advertising Bureau (IAB) standard, for the terrestrial portion 400A and/or the aircraft-based portion 400B of the advertisement system 400. Exemplary standards can comprise global standards, including global standards regarding pricing, packaging, creative advertisement units, measurement of user response 210R, technology platforms, business models, and/or technical operations. Alternatively, and/or additionally, the lack of standards associated with conventional information systems can be addressed via independent auditing of the advertisement system 400.

FIG. 6 shows a preferred embodiment of the advertisement system 400 as configured for use with a vehicle information system 300 installed aboard a passenger vehicle 390, such as an aircraft 390B. The advertisement content source 410 of the advertisement system 400 can be in communication with at least one content source 310 such as an advertisement database system 416 and/or a viewing content (or media) database system 310D. Being provided as conventional database systems, the advertisement database system 416 is configured to store and/or retrieve (or provide) advertisement content 210A; whereas, the media database system 310D can store and/or retrieve (or provide) viewing content 210. In other words, the advertisement content source 410 can exchange the advertisement content 210A with the advertisement database system 416 and/or can exchange the viewing content 210 with the media database system 310D.

The advertisement content source 410 likewise is illustrated as being in communication with a user (or passenger) interface system 360 of the vehicle information system 300. Being provided in the manner set forth in more detail above with reference to FIGS. 4A-B, the passenger interface system 360 is associated with a selected passenger seat 382 and/or can include a video presentation system 362, an audio presentation system 364, and/or a user input system 366 for enabling a system user (or passenger) 412 (shown in FIG. 1B) to interact with the vehicle information system 300. The passenger interface system 360 is shown as including an iCore system 360A and/or a digital signal processing (DSP) system 360B. The passenger interface system 360 likewise can communicate with a media server system 310A of the vehicle information system 300.

Operation of the advertisement system 400 of FIG. 6 is illustrated with reference to FIGS. 7A-Z, wherein advertisement content 210A is included with viewing content 210 selected for presentation at a passenger seat 382. Turning to FIG. 7A, a system user (or passenger) 412 (shown in FIG. 1B) associated with the passenger seat 382 uses the user interface system 360 of the vehicle information system 300 to select viewing content 210, such as a movie 210M, for presentation at the passenger seat 382. FIG. 7B shows that the user interface system 360 communicates with the advertisement content source 410 to initiate generation of an aggregate play list 440 (shown in FIG. 7D) for presenting the selected viewing content 210. Initiating the generation of the aggregate play list 440, the advertisement content source 410 can communicate with the media database system 310D to request one or more aggregate content items 444 (shown in FIG. 7D). The media database system 310D can provide the aggregate play list 440 to the advertisement content source 410 as illustrated in FIG. 7D.

The aggregate play list 440 preferably includes a plurality of aggregate content items 444. Each aggregate content item 444 can be associated with a content (or MID) identification indicia 442A, a viewing time duration 442B, and/or a content type 442C. As shown in FIG. 7D, for example, the aggregate play list 440 can include three aggregate content items 444A-C. If associated with fixed advertisement content 210F (shown in FIG. 7K), the first aggregate content item 444A can be associated with a content type 442C of “FixedAd.” The first aggregate content item 444A likewise is shown as having a viewing time duration 442B of thirty seconds and as being associated with a content identification indicia 442A of “3001.” The fixed advertisement content 210F comprise targeted advertisement content 210A and/or advertisement content 210A that is presented regardless of user preferences.

Having an undefined viewing time duration 442B, the second aggregate content item 444B of FIG. 7D is illustrated as being associated with a content type 442C of “AdSpot” and with a content identification indicia 442A of “9000.” The advertisement content source 410 can define the viewing time duration 442B upon selecting the advertisement content 210A to be associated with the second aggregate content item 444B. The movie 210M can be associated with the third aggregate content item 444C, which has a content type 442C of “Movie” The first aggregate content item 444A of the third aggregate content item 444C is shown as having a viewing time duration 442B of seven thousand, two hundred seconds (or two hours) and as being associated with a content identification indicia 442A of “5004.”

FIG. 7E shows that the user interface system 360 can communicate with the advertisement content source 410 to facilitate selection of the advertisement content 210A to be presented with the fixed advertisement content 210F (shown in FIG. 7K) and the advertisement content 210A. To select the targeted advertisement content 210A, the advertisement content source 410 communicates with the advertisement database system 416 to retrieve the targeted advertisement content 210A as shown in FIG. 7F. The advertisement content source 410 completes generation of the aggregate play list 440 by inserting the targeted advertisement content 210A into the aggregate play list 440 as illustrated in FIG. 7G. The second aggregate content item 444B thereby can be updated to include a content identification indicia 442A of “8002,” a viewing time duration 442B of forty-five seconds, and a content type 442C of “Advert.” The completed aggregate play list 440 is shown in FIG. 7H.

Turning to FIG. 7I, the advertisement content source 410 communicates with the passenger interface system 360 to initiate presentation of the viewing content 210 associated with the aggregate play list 440. FIG. 7J shows the passenger interface system 360 communicating with the media server system 310A to access the viewing content 210 associated with the aggregate play list 440. The vehicle information system 300 can generate and/or present a playback timeline 450 to illustrate the viewing content 210 to be presented. As shown in FIG. 7K, the playback timeline 450 can illustrate that the fixed advertisement content 210F is scheduled for presentation during a thirty-second time interval extending from time t=0 seconds to time t=30 seconds. The targeted advertisement content 210A likewise can be scheduled for presentation during a forty-five-second time interval extending from time t=30 seconds to time t=75 seconds; whereas, the movie 210M, can be scheduled for presentation during a seven thousand, two hundred-second time interval extending from time t=75 seconds to time t=7275 seconds.

As shown in FIG. 7K, the passenger interface system 360 can begin to present the fixed advertisement content 210F beginning at time t=0 seconds. The media server system 310A preferably streams the fixed advertisement content 210F to the passenger interface system 360 throughout the thirty-second time interval extending from time t=0 seconds to time t=30 seconds. The fixed advertisement content 210F thereby is presented via the passenger interface system 360 during the thirty-second time interval extending from time t=0 seconds to time t=30 seconds as illustrated in FIGS. 7K-M.

At time t=30.01 seconds, the passenger interface system 360 can begin to present the targeted advertisement content 210A via the passenger interface system 360 as shown in FIG. 7N. The passenger interface system 360 likewise can communicates a user response 210R (shown in FIG. 5A) to the advertisement content source 410, which can provide the user response 210R to the advertisement-serving system 420 (shown in FIG. 5A) in the manner set forth in more detail above. The user response 210R can represent that the targeted advertisement content 210A has been presented. The media server system 310A preferably streams the targeted advertisement content 210A to the passenger interface system 360 throughout the forty-five-second time interval extending from time t=30 seconds to time t=75 seconds. The targeted advertisement content 210A thereby is presented via the passenger interface system 360 during the forty-five-second time interval extending from time t=30 seconds to time t=75 seconds as illustrated in FIGS. 7N-P.

FIG. 7Q shows that the system user (or passenger) 412 (shown in FIG. 1B) can activate (or select) the associated advertisement impression 630 (shown in FIG. 5B) at time t=60 seconds. Upon activating the advertisement impression 630, the vehicle information system 300 can suspend presentation of the targeted advertisement content 210A as illustrated in FIG. 7R. In other words, the media server system 310A can suspend streaming the targeted advertisement content 210A to the passenger interface system 360. As shown in FIG. 7S, the passenger interface system 360 can communicate a user response 210R (shown in FIG. 5A) to the advertisement content source 410. The user response 210R can represent that the targeted advertisement content 210A has been accessed via activation of the advertisement impression 630. As discussed in more detail above, the advertisement content source 410 can provide the user response 210R to the advertisement-serving system 420 (shown in FIG. 5A).

Turning to FIG. 7T, the advertisement content source 410 can receive the user response 210R (shown in FIG. 5A) and can provide enhanced advertisement content 210A available from a micro-site. The advertisement content source 410 provides the enhanced advertisement content 210A to the passenger interface system 360 for presentation. The passenger interface system 360 then presents the enhanced advertisement content 210A as shown in FIG. 7U. The passenger interface system 360 can present the enhanced advertisement content 210A in its entirety, and/or, as illustrated in FIG. 7V, the presentation of the enhanced advertisement content 210A can be terminated by the system user (or passenger) 412 (shown in FIG. 1B).

Once the presentation of the enhanced advertisement content 210A is completed and/or terminated, the vehicle information system 300 can return to presenting the viewing content 210 in accordance with the aggregate play list 440. The passenger interface system 360 can access the aggregate play list 440 as shown in FIG. 7W and can communicate with the media server system 310A as shown in FIG. 7X. The passenger interface system 360 thereby can request the remaining viewing content 210 from the media server system 310A. Turning to FIG. 7Y, the media server system 310A resumes streaming the advertisement content 210A to the passenger interface system 360 in accordance in accordance with the aggregate play list 440. The passenger interface system 360 thereby can present the remaining fifteen seconds of the advertisement content 210A during the fifteen-second time interval extending from time t=60 seconds to time t=75 seconds and then proceeds to present the movie 210M during the seven thousand, two hundred-second time interval extending from time t=75 seconds to time t=7275 seconds as illustrated in FIG. 7Z.

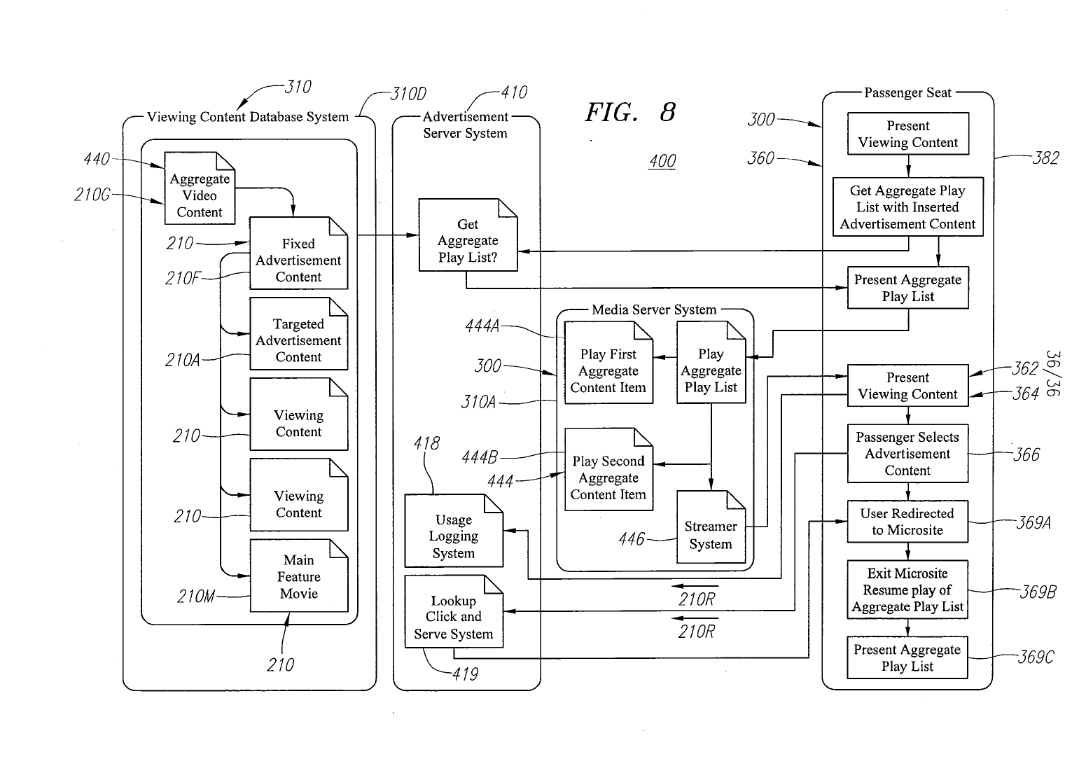

The vehicle information system 300 thereby presents each aggregate content item 444 as set forth in the aggregate play list 440. Although the aggregate content items 444 can be presented in any conventional manner, the vehicle information system 300 preferably does not present the aggregate content items 444 individual. In other words, the aggregate content items 444 preferably are presented as parts of the aggregate play list 440. The media server system 310A receives the aggregate play list 440 from the passenger interface system 360 and builds the aggregate viewing content 210G (shown in FIG. 8). The media server system 310A can collate the individual viewing content 210, such as the fixed advertisement content 210F, the targeted advertisement content 210A, and/or the movie 210M, and streams the aggregate viewing content 210G, including any advertisement insertions, to the passenger interface system 360 for presentation. The passenger interface system 360 can determine which part of the aggregate viewing content 210G has been presented and/or is currently being presented based, for example, upon the viewing content 210 that is currently being presented.

FIG. 8 is a detail drawing illustrating an embodiment of the advertisement system of FIG. 6. As shown in FIG. 8, the media database system 310D can generate the aggregate viewing content 210G in accordance with the aggregate play list 440. The aggregate viewing content 210G is illustrated as comprising a sequence of selected viewing content 210. In the manner set forth in more detail above with reference to FIGS. 7A-Z, the aggregate play list 440 can include any suitable number of aggregate content items 444 (shown FIG. 7D). The aggregate viewing content 210G of FIG. 8, for example, can include the fixed advertisement content 210F, such as an airline image, and the targeted advertisement content 210A. Other viewing content 210, such as the movie 210M, selected by the system user (or passenger) 412 (shown in FIG. 1B) can be included with the aggregate viewing content 210G.

The advertisement content source 410 can receive the aggregate play list 440 from the media database system 310D and, as desired, modify the aggregate play list 440. Thereby, the advertisement content source 410 can add and/or remove selected viewing content 210 from the aggregate play list 440 and/or modify the sequence of the viewing content 210 within the aggregate play list 440. The advertisement content source 410 can provide the resultant aggregate play list 440 to the passenger interface system 360 of the vehicle information system 300. The passenger interface system 360 thereby can present the viewing content 210 in accordance with the resultant aggregate play list 440 at the passenger seat 382. When playback of the viewing content 210 is initiated, the passenger interface system 360 can provide the resultant aggregate play list 440 to the media server system 310A, which can retrieve the associated viewing content 210. The media server system 310A can provide (or stream) the viewing content 210 to the passenger interface system 360 via a viewing content streaming system 460.

The streamed viewing content 210 can be presented via the video presentation system 362 and/or the audio presentation system 364 of the passenger interface system 360. When presentation of the streamed viewing content 210 is initiated, the passenger interface system 360 provides a user response 210R to a usage logging system 418 of the advertisement content source 410. The advertisement content source 410 can provide the user response 210R to the advertisement-serving system 420 (shown in FIG. 5A) in the manner set forth in more detail above. The user response 210R can represent that the targeted advertisement content 210A has been presented.

The user input system 366 of the passenger interface system 360 can enable the system user 412 to activate (or otherwise select) advertisement content 210A presented by the passenger interface system 360. If the system user 412 selects an advertisement impression 630 (shown in FIG. 5B), the passenger interface system 360 can generate another user response 210R for initiating presentation of the associated advertisement content 210A. The advertisement content source 410 can include a Lookup Click and Serve system 419 that receives and records (or measures) the user response 210R. The advertisement content source 410 thereby can, at 369A, instruct the passenger interface system 360 to redirect the system user 412 to enhanced advertisement content 210A available from a predetermined micro-site. When presentation of the enhanced advertisement content 210A is complete (or terminated by the system user 412), the passenger interface system 360, at 369B, can exit the predetermined micro-site and resume playback of the viewing content 210 associated with the aggregate play list 440. At 369C, the vehicle information system 300 then can proceed with presentation of the viewing content 210 associated with the aggregate play list 440.

As desired, the inventory of available advertisement content 210A can be increased by providing the advertisement system 400 with additional branded viewing content 210. Exemplary categories of branded viewing content 210 can include travel (and destinations), lifestyle (such as food, drink, and/or fashion), sports, business (and finance), entertainment (including puzzles, comics and/or games), health (and well being), literature (including books and book reviews), automotive (including driving and car reviews), technology, and/or children content. The advertisement content 210A advantageously can be presented via interactive passenger interface systems 360, such as touchscreen display systems, to increase the inventory of most valuable advertisement content 210A. The inventory of most valuable advertisement content 210A likewise can be increased by presenting a larger number of advertisements per page and/or by increasing a refresh rate on static interactive pages. As desired, the advertisement system 400 can support price differentiation for impressions 630 (shown in FIG. 5B) provided to passengers seats 382 associated in different passenger seat classes, such as first class, business class, and economy class. Additionally, and/or alternatively, selected functions of the vehicle information system 300 can be sponsored by advertisers. Sponsorships for the selected system functions, for example, can be auctioned off among a group of advertisers.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A vehicle information system suitable for installation aboard a passenger vehicle, comprising:
a content source;
a user interface system that includes a user input system for selecting viewing content available from said content source and a content presentation system; and
an advertisement content source that combines advertising content with the selected viewing content to generate an aggregate play list and that provides the aggregate play list to said user interface system for presentation of the advertising content and the selected viewing content in accordance with the aggregate play list via said content presentation system,
wherein, during presentation of the aggregate play list, said user interface system provides a user response to the presented advertisement content to said advertisement content source, said advertisement content source compiling the user response.

2. The vehicle information system of claim 1, wherein said content source comprise a media server system installed aboard the passenger vehicle.

3. The vehicle information system of claim 1, wherein said content source is disposed remotely from the passenger vehicle.

4. The vehicle information system of claim 1, further comprising a content distribution system that supports communication among said content source, said user interface system, and said advertisement content source.

5. The vehicle information system of claim 4, wherein said content distribution system comprises a wired content distribution system.

6. The vehicle information system of claim 1, wherein the advertising content is selected from a group consisting of a banner advertisement, a pop-up advertisement, an advertisement button, a skyscraper, and a micro-site.

7. The vehicle information system of claim 1, wherein said content presentation system includes an audio presentation system that presents an audio portion of the selected viewing content and the advertising content associated with the aggregate play list.

8. The vehicle information system of claim 1, wherein said content presentation system includes a video presentation system that presents a video portion of the selected viewing content and the advertising content associated with the aggregate play list.

9. The vehicle information system of claim 1, wherein said video presentation system presents a selectable advertisement impression, and wherein said user input system can activate the selectable advertisement impression to initiate presentation of the advertisement content.

10. The vehicle information system of claim 9, wherein said user interface system provides the user response to the presented advertisement content upon activation of the selectable advertisement impression.

11. The vehicle information system of claim 1, wherein said user interface system provides the user response to the presented advertisement content upon initiation of the presentation of the aggregate play list.

12. The vehicle information system of claim 1, wherein said advertisement content source communicates with an advertisement-serving system that provides the advertisement content to said advertisement content source and that receives the user response from said advertisement content source.

13. The vehicle information system of claim 12, wherein the advertisement-serving system comprises a terrestrial advertisement-serving system.

14. The vehicle information system of claim 12, wherein the advertisement-serving system manages a plurality of advertisement-sales systems associated with a plurality of advertisers, each of the advertisement-sales systems providing the advertisement content of the relevant advertiser to the advertisement-serving system and receiving the user response associated with the relevant advertiser from the advertisement-serving system.

15. The vehicle information system of claim 12, wherein the advertisement-serving system provides the advertisement content to a plurality of advertisement content sources associated with a plurality of vehicle information systems.

16. The vehicle information system of claim 15, wherein the advertisement-serving system simultaneously provides the advertisement content to said plurality of said advertisement content sources.

17. The vehicle information system of claim 15, wherein the advertisement-serving system filters the advertisement content based upon a predetermined filtering criteria such that suitable advertisement content is provided to said advertisement content source.

18. The vehicle information system of claim 12, wherein the advertisement-serving system analyzes the user response to measure an effectiveness of the advertisement content for a selected advertiser and provides advertisement effectiveness information to the selected advertiser.

19. The vehicle information system of claim 1, wherein said advertisement content source filters the advertisement content based upon a predetermined filtering criteria such that targeted advertisement content is provided to said user interface system.

20. The vehicle information system of claim 1, wherein the advertisement content is provided in an Internet-standard advertisement format.

21. The vehicle information system of claim 1, wherein the vehicle information system is suitable for installation aboard an aircraft.

22. A method for providing advertisement content aboard via a vehicle information system, comprising:
providing the vehicle information system having:
a media server system; and
a user interface system that includes a user input system for selecting viewing content available from said media server system and a content presentation system;
combining advertising content with the selected viewing content to generate an aggregate play list;
providing the aggregate play list to said user interface system for presentation of the advertising content and the selected viewing content in accordance with the aggregate play list via said content presentation system; and
during presentation of the aggregate play list,
receiving a user response to the presented advertisement content from the user interface system; and
compiling the user response.

23. The method of claim 22, further comprising filtering the advertisement content based upon a predetermined filtering criteria such that targeted advertisement content is provided to said user interface system

24. The method of claim 22, further comprising receiving the advertisement content from an advertisement-serving system and providing the user response to the advertisement-serving system.

25. An advertisement system suitable for use with a vehicle information system having a media server system and a user interface system that includes a user input system for selecting viewing content available from the media server system and a content presentation system, said advertisement system comprising:
an advertisement content source that combines advertising content with the selected viewing content to generate an aggregate play list and that provides the aggregate play list to the user interface system for presentation of the advertising content and the selected viewing content in accordance with the aggregate play list via the content presentation system; and
an advertisement-serving system that provides the advertisement content to said advertisement content source,
wherein, during presentation of the aggregate play list, the user interface system provides a user response to the presented advertisement content to said advertisement-serving system via said advertisement content source, said advertisement-serving system compiling the user response.

26. The advertisement system of claim 25, wherein said advertisement content source is disposed adjacent to the vehicle information system.

27. The advertisement system of claim 26, wherein said advertisement content source and the vehicle information system are disposed in a passenger vehicle.

28. The advertisement system of claim 27, wherein said advertisement content source and the vehicle information system are disposed in an aircraft.

29. The advertisement system of claim 25, wherein said advertisement-serving system comprises a terrestrial advertisement-serving system.

30. The advertisement system of claim 25, wherein said advertisement-serving system manages a plurality of advertisement-sales systems associated with a plurality of advertisers, each of the advertisement-sales systems providing the advertisement content of the relevant advertiser to said advertisement-serving system and receiving the user response associated with the relevant advertiser from said advertisement-serving system.

31. The advertisement system of claim 25, wherein said advertisement-serving system provides the advertisement content to a plurality of advertisement content sources.

32. The advertisement system of claim 31, wherein said advertisement-serving system simultaneously provides the advertisement content to said plurality of said advertisement content sources.

33. The advertisement system of claim 31, wherein said plurality of said advertisement content sources are associated with a plurality of vehicle information systems.

34. The advertisement system of claim 31, wherein said advertisement-serving system filters the advertisement content based upon a predetermined filtering criteria such that suitable advertisement content is provided to said advertisement content source.

35. The advertisement system of claim 25, wherein said advertisement-serving system analyzes the user response to measure an effectiveness of the advertisement content for a selected advertiser and provides advertisement effectiveness information to the selected advertiser.

36. The advertisement system of claim 25, wherein said advertisement content source filters the advertisement content based upon a predetermined filtering criteria such that targeted advertisement content is provided to the user interface system.

37. An aircraft, comprising:
a fuselage and a plurality of passenger seats arranged within the fuselage; and
a vehicle information system, said vehicle information system coupled with said fuselage and comprising:
a headend system that provides overall system control functions for the vehicle information system and that includes a content source;
a user interface system that includes a user input system for selecting viewing content available from said content source and a content presentation system; and
a content distribution system that distributes the selected viewing content throughout the vehicle information system; and
an advertisement content source that combines advertising content with the selected viewing content to generate an aggregate play list and that provides the aggregate play list to said user interface system for presentation of the advertising content and the selected viewing content in accordance with the aggregate play list via said content presentation system,
wherein, during presentation of the aggregate play list, said user interface system provides a user response to the presented advertisement content to said advertisement content source, said advertisement content source compiling the user response.
